(19) United States
(12) Patent Application Publication
(10) Pub. No.: US 2007/0268977 A1
(43) Pub. Date: Nov. 22, 2007

(54) METHOD OF UTILIZING AND MANIPULATING WIRELESS RESOURCES FOR EFFICIENT AND EFFECTIVE WIRELESS COMMUNICATION

(75) Inventors: Shu Wang, San Diego, CA (US); Sang G. Kim, San Diego, CA (US); Young C. Yoon, San Diego, CA (US); Soon Yil Kwon, San Diego, CA (US); Li-Hsiang Sun, San Diego, CA (US); Ho Bin Kim, San Diego, CA (US); Suk Woo Lee, San Diego, CA (US); Byung K. Yi, San Diego, CA (US)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/751,512

(22) Filed: May 21, 2007

Related U.S. Application Data
(60) Provisional application No. 60/801,689, filed on May 19, 2006.
(60) Provisional application No. 60/896,831, filed on Mar. 23, 2007.
(60) Provisional application No. 60/909,906, filed on Apr. 3, 2007.
(60) Provisional application No. 60/910,420, filed on Apr. 5, 2007.

(51) Int. Cl. H04L 5/12

(52) U.S. Cl. 375/261

(57) ABSTRACT

A method of allocating symbols in a wireless communication system is disclosed. More specifically, the method includes receiving at least one data stream from at least one user, grouping the at least one data streams into at least one group, wherein each group is comprised of at least one data stream, preceding each group of data streams in multiple stages, and allocating the precoded symbols.

This application claims the benefit of U.S. Provisional Application No. 60/801,689 filed on May 19, 2006, U.S. Provisional Application No. 60/896,831 filed on Mar. 23, 2007, U.S. Provisional Application No. 60/909,906 filed on Apr. 3, 2007, and U.S. Provisional Application No. 60/910,420 filed on Apr. 5, 2007, which are hereby incorporated by reference.

### BACKGROUND OF THE INVENTION

1. Field of the Invention

The present invention relates to a method of using wireless resources, and more particularly, to a method of utilizing and manipulating wireless resources for efficient and effective wireless communication.

2. Discussion of the Related Art

In the world of cellular telecommunications, those skilled in the art often use the terms 1G, 2G, and 3G. The terms refer to the generation of the cellular technology used. 1G refers to the first generation, 2G to the second generation, and 36 to the third generation.

1G refers to the analog phone system, known as an AMPS (Advanced Mobile Phone Service) phone systems. 2G is commonly used to refer to the digital cellular systems that are prevalent throughout the world, and include CDMAOne, Global System for Mobile communications (OSM), and Time Division Multiple Access (TDMA). 2G systems can support a greater number of users in a dense area than can 1G systems.

3G commonly refers to the digital cellular systems currently being deployed. These 3 G communication systems are conceptually similar to each other with some significant differences.

In a wireless communication system, an effective transmission of data crucial and at the same time, it is important to improve transmission efficiency. To this end, it is important that more efficient ways of transmitting and receiving data are developed.

### SUMMARY OF TUE INVENTION

Accordingly, the present invention is directed to a method of utilizing and manipulating wireless resources for efficient and effective wireless communication that substantially obviates one or more problems due to limitations and disadvantages of the related art.

An object of the present invention is to provide a method allocating symbols in a wireless communication system.

Another object of the present invention is to provide a method of performing hierarchical modulation signal constellation in a wireless communication system.

A further object of the present invention is to provide a method of transmitting more than one signal in a wireless communication system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of allocating symbols in a wireless communication system includes receiving at least one data stream from at least one user, grouping the at least one data streams into at least one group, wherein each group is comprised of at least one data stream, precoding each group of data streams in multiple stages, and allocating the precoded symbols.

In another aspect of the present invention, a method of performing hierarchical modulation signal constellation in a wireless communication system includes allocating multiple symbols according to a bits-to-symbol mapping rule representing different signal constellation points with different bits, wherein the mapping rule represents one (1) or less bit difference between closest two symbols.

In a further aspect of the present invention, a method of transmitting more than one signal in a wireless communication system includes allocating multiple symbols to a first signal constellation and to a second constellation, wherein the first signal constellation refers to base layer signals and the second signal constellation refers to enhancement layer signals, modulating the multiple symbols of the first signal constellation and the second signal constellation, and transmitting the modulated symbols.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is an exemplary diagram of a generalized MC-CDM structure;

FIG. 2 is another exemplary diagram of a generalized MC-CDM structure;

FIG. 3 is an exemplary diagram illustrating a generalized MC-CDM structure in which precoding/rotation is performed on groups;

FIG. 4 is an exemplary diagram illustrating a multi-stage rotation;

FIG. 5 is another exemplary diagram of a generalized MC-CDM structure;

FIG. 6 is an exemplary diagram illustrating frequency-domain interlaced MC-CDM;

FIG. 7 is an exemplary diagram illustrating an example of Gray coding;

FIG. 8 is an exemplary diagram illustrating mapping for regular QPSK/QPSK hierarchical modulation or 16 QAM modulation;

FIG. 9 is an exemplary diagram illustrating bits-to-symbol mapping for 16 QAM/QPSK;

FIG. 10 is another exemplary diagram illustrating bits-to-symbol mapping for 16 QAM/QPSK;

FIG. 11 is another exemplary diagram illustrating bits-to-symbol mapping for 16 QAM/QPSK;

FIG. 12 is another exemplary diagram illustrating bits-to-symbol mapping for 16 QAM/QPSK;

FIG. 13 is an exemplary diagram illustrating bits-to-symbol mapping for QPSK/QPSK;

FIG. 14 is an exemplary diagram illustrating an enhancement layer bits-to-symbol for base layer 0x0;

FIG. 15 is an exemplary diagram illustrating an enhancement layer bits-to-symbol for base layer 0x1;

FIG. 16 is an exemplary diagram showing the signal constellation of the layered modulator with respect to QPSK/QPSK hierarchical modulation;

FIG. 17 is an exemplary diagram illustrating the signal constellation of the layered modulator with respect to 16 QAM/QPSK hierarchical modulation;

FIG. 18 is an exemplary diagram showing the signal constellation for the layered modulator with QPSK/QPSK hierarchical modulation;

FIG. 19 is an exemplary diagram illustrating the signal constellation of the layered modulator with respect to 16 QAM/QPSK hierarchical modulation;

FIG. 20 is an exemplary diagram illustrating signal constellation for layered modulation with QPSK base layer and QPSK enhancement layer;

FIG. 21 is an exemplary diagram illustrating the signal constellation of the layered modulator with respect to 16 QAM/QPSK hierarchical modulation;

FIG. 22 is an exemplary diagram illustrating Gray mapping for rotated QPSK/QPSK hierarchical modulation;

FIG. 23 is an exemplary diagram illustrating an enhanced QPSK/QPSK hierarchical modulation;

FIG. 24 is an exemplary diagram illustrating a new QPSK/QPSK hierarchical modulation;

FIG. 25 is another exemplary diagram illustrating a new QPSK/QPSK hierarchical modulation; and

FIG. 26 is an exemplary diagram illustrating a new bit-to-symbol block.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

An orthogonal frequency division multiplexing (OFDM) is a digital multi-carrier modulation scheme, which uses a large number of closely-spaced orthogonal sub-carriers. Each sub-carrier is usually modulated with a modulation scheme (e.g., quadrature phase shift keying (QPSK)) at a low symbol rate while maintaining data rates similar to conventional single-carrier modulation schemes in the same bandwidth.

The OFDM originally does not have frequency diversity effect, but it can obtain frequency diversity effect by use of forward error correction (FEC) even in a distributed mode. That is, the frequency diversity effect becomes low when the channel coding rate is high.

In view of this, multi-carrier code division multiplexing (MC-CDM) or a multi-carrier code division multiple access (MC-CDMA) with advanced receiver can be used to compensate for low frequency diversity effect due to high channel coding rate.

The MC-CDM or MC-CDMA is a multiple access scheme used in OFDM-based system, allowing the system to support multiple users at the same time. In other words, the data can be spread over a much wider bandwidth than the data rate, a signal-to-noise and interference ratio can be minimized.

For example, with respect to signal processing, a channel response for each OFDM tone (or signal or sub-carrier) can be modeled as identical independent complex Gaussian variable. By doing so and using MC-CDM, diversity gain and processing gain can be attained. I-ere, interference, such as inter-symbol interference (ISI) or multiples access interference (MAI), is temporarily omitted in part due to the cyclic prefix or zero padding employed by OFDM or MC-CDM.

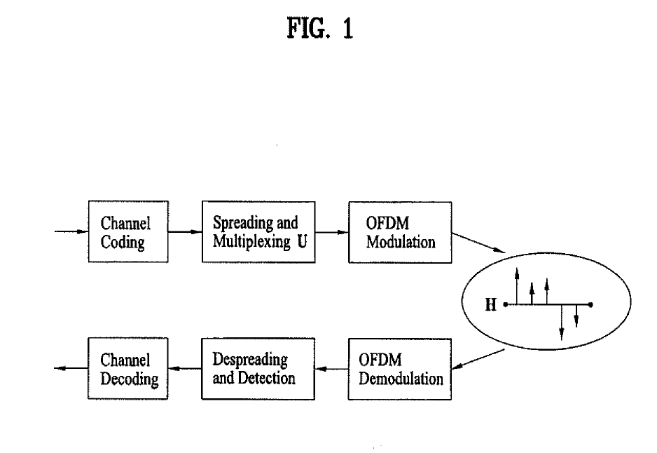

FIG. 1 is an exemplary diagram of a generalized MC-CDM structure. Referring to FIG. 1,

$$\tilde{H} = [ \begin{matrix}{\tilde{h}}_{1} & \\ & {\tilde{h}}_{2}\end{matrix} ]$$

denotes the frequency response of fading channel, where \tilde{h}₁ is a complex Gaussian variable for the frequency-domain channel response of each sub-carrier. Furthermore, without loss of the generality,

$${U}_{2} = [ \begin{matrix}α & β \\ - {β}^{*} & {α}^{*}\end{matrix} ]$$

denote the unitary symbol preceding matrix with power constraint |α|²+|β|²=1. It can be taken a generalization of the classic MC-CDM.

The processes of FIG. 1 include channel coding followed by spreading and multiplexing (which can be represented by U). Thereafter, the multiplexed data is modulated by using the OFDM modulation scheme.

At the receiving end, the OFDM modulated symbols are demodulated using OFDM demodulation scheme. They are then despread and detected, followed by channel decoding.

Further to the generalized MC-CDM structure, other structures are available such as rotated MC-CDM, OFDM, rotational OFDM (R-OFDM), or Walsh-Hadamard MC-CDM.

With respect to rotated MC-CDM, if α=cos(θ₁) and β=sin(θ₁), then a real-value rotation matrix can be available as follows in Equation 1.

$${R}_{2} ( {θ}_{1} ) = [ \begin{matrix}cos ( {θ}_{1} ) & sin ( {θ}_{1} ) \\ - sin ( {θ}_{1} ) & cos ( {θ}_{1} )\end{matrix} ] \\ {R}_{2}^{- 1} ( {θ}_{1} ) = {R}_{2}^{H} ( {θ}_{1} ) = [ \begin{matrix}cos ( {θ}_{1} ) & - sin ( {θ}_{1} ) \\ sin ( {θ}_{1} ) & cos ( {θ}_{1} )\end{matrix} ] \qquad [ Equation 1 ]$$

Furthermore, with respect to OFDM, if αβ=0 or αβ*=0, then U, becomes I₂. In other words, U₂ becomes uncoded OFDM or uncoded OFDMA. In addition, with respect to Walsh-Hadamard MC-CDM, if

$$α = cos ( \frac{π}{4} ) = \frac{\sqrt{2}}{2} and β = sin ( \frac{π}{4} ) = \frac{\sqrt{2}}{2} ,$$

U₂=R₂ become a classic Walsh-Hadamard matrix.

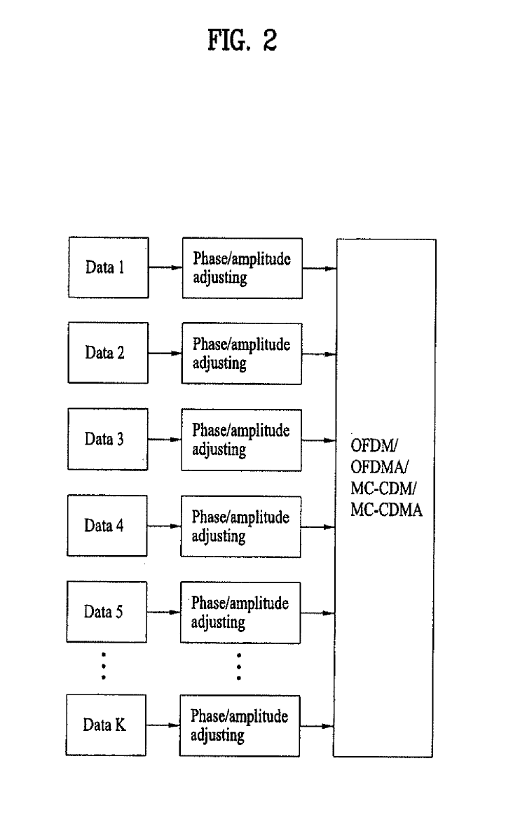

FIG. 2 is another exemplary diagram of a generalized MC-CDM structure. In FIG. 2, a plurality of data are inputted which are then precoded and/or rotated. Here, the preceding or rotation also can signify adjustment of the amplitude and/or phase of incoming data.

With respect to precoding/rotation, different tones or sub-carriers may be precoded/rotated independently or jointly. Here, the joint precoding/rotation of the incoming data or data streams can be performed by using a single rotation matrix. Alternatively, different incoming data or data streams can be separated into multiple groups, where each group of data streams can be precoded/rotated independently or jointly.

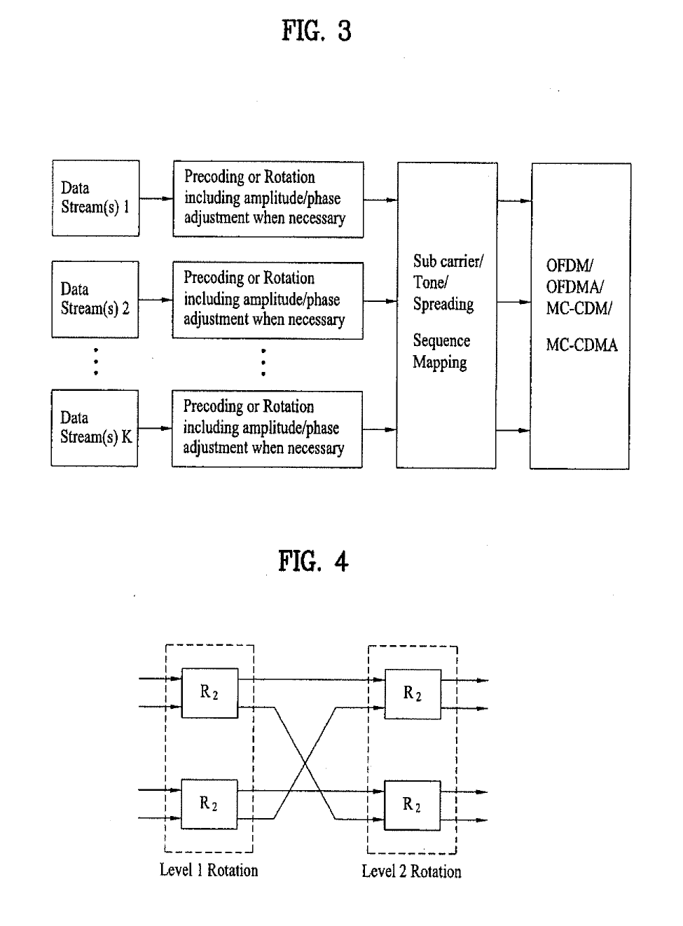

FIG. 3 is an exemplary diagram illustrating a generalized MC-CDM structure in which precoding/rotation is performed on groups. Referring to FIG. 3, multiple data or data streams are grouped into Data Stream(s) 1, 2, . . . , K groups which are then precoded/rotated per group. Here, the precoding/rotation can include amplitude and/or phase adjustment, if necessary. Thereafter, the precoded/rotated symbols are mapped.

Further, different rotation/precoding on different groups may lead to a mixture of OFDM, MC-CDM or R-OFDM. In addition, the rotation/precoding of each group may be based on the QoS requirement, the receiver profile, and/or the channel condition.

Alternatively, instead of using a big precoding/rotation matrix, a smaller-sized precoding/rotation matrix can be dependently or independently applied to different groups of incoming data streams.

In operation, actual precoding/rotation operation can be performed in multiple stages. FIG. 4 is an exemplary diagram illustrating a multi-stage rotation. Referring to FIG. 4, multiple data or data streams are inputted which are then precoded/rotated. Here, these processed symbols can be grouped into at least two groups. Each group is represented by at least one symbol.

With respect to rotation of the symbols, the symbol(s) of each group can be spread using a spreading matrix. Here, the spreading matrix that is applied to a group may be different and can be configured. After the symbols are processed through the spreading matrix, then the output(s) can be re-grouped into at least two groups. Here, the re-grouped outputs comprise at least one selected output from each of the at least two groups.

Thereafter, these re-grouped outputs can be spread again using the spreading matrix. Again, the spreading matrix that is applied to a group may be different and can be configured. After the outputs are processed through another spreading matrix, they are inputted to an inverse fast Fourier transform (IFFT).

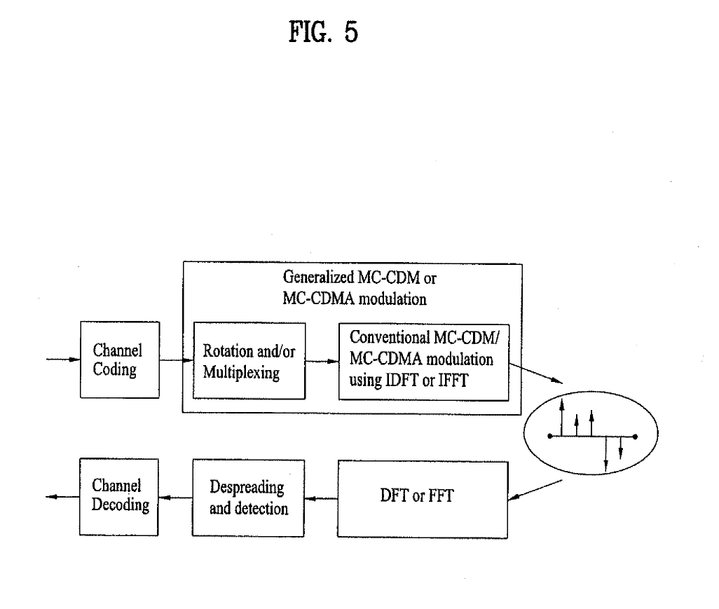

A rotation scheme such as the multi-stage rotation can also be employed by a generalized MC-CDM or multi-carrier code division multiple access (MC-CDMA). FIG. 5 is an exemplary diagram illustrating a general block of the MC-CDM.

FIG. 5 is another exemplary diagram of a generalized MC-CDM structure. More specifically, the processes as described with respect to FIG. 5 are similar to those of FIG. 1 except that FIG. 5 is based on generalized MC-CDM or MC-CDMA that uses rotation (e.g., multi-stage rotation). Here, after channel coding, the coded data are rotated and/or multiplexed, followed by modulation using inverse discrete Fourier transform (IDFT) or IFFT.

At the receiving end, the modulated symbols are demodulated using discrete Fourier transform (DFT) or fast Fourier transform (FFT). They are then despread and detected, followed by channel decoding.

In addition, interlacing is available in the generalized MC-CDM. In 1x evolution data optimized (1xEV-DO) BCMCS and enhanced BCMCS (EBCMCS), the multipath delay spread is about T_{d}=3.7 μs and the coherent bandwidth is around

$${B}_{c} = \frac{1}{{T}_{d}} = 270 kHz .$$

Therefore, the maximum frequency diversity order is

$$d = \frac{B}{{B}_{c}} = \frac{1.25}{0.27} \approx 5.$$

This means, in order to capture the maximum frequency diversity here, the MC-CDM spreading gain L≧5 is possibly enough.

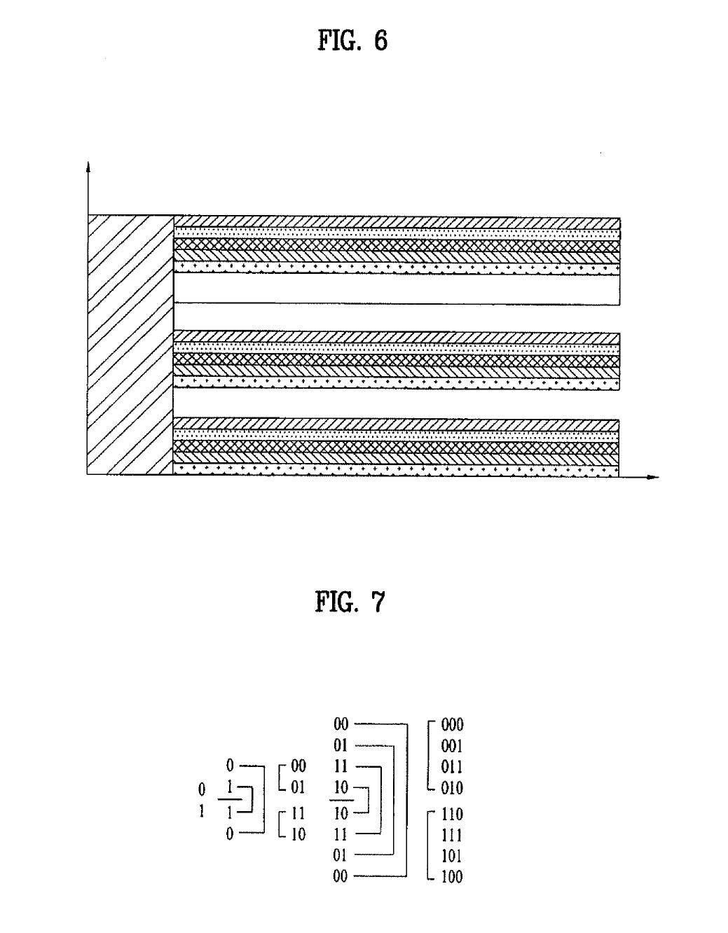

Based on the above analysis, a frequency-domain interlaced MC-CDM can be used. FIG. 6 is an exemplary diagram illustrating frequency-domain interlaced MC-CDM. Referring to FIG. 6, each slot, indicated by different fills, can be one tone (or sub-carrier) or multiple consecutive tones (or sub-carriers).

The tone(s) or sub-carrier(s) or symbol(s) can be rotated differently. In other words, the product distance, which can be defined as the product of Euclidean distances, can be maximized. In detail, a minimum product distance, which is used for optimizing modulation diversity, can be shown by the following equation. The minimum product distance can also be referred to as Euclidean distance minimization.

$${D}_{p} = min {\prod }_{i \neq j , {s}_{i} ∈ A} \vert {s}_{i} - {s}_{j} \vert \qquad [ Equation 3 ]$$

Referring to Equation 3, sᵢεA denotes the transmitted symbols. Furthermore, optimization with maximizing the minimum production distance can be done by solving the following equation.

$${U}_{2} ( {ⅇ}^{jϕ} ) = {arg max}_{U} {D}_{p} = {arg max}_{U} min {\prod }_{i \neq j , {s}_{i} ∈ A} \vert {Us}_{i} - {Us}_{j} \vert \qquad [ Equation 4 ]$$

Referring to Equation 4,

$${U}_{2} ( {ⅇ}^{jϕ} ) = [ \begin{matrix}α & {αⅇ}^{jϕ} \\ - {α}^{*} {ⅇ}^{- jϕ} & {α}^{*}\end{matrix} ] .$$

For example, for the traditional quadrature phase shift keying (QPSK), U₂(e^{jφ}) can be decided by calculating

$$d ( {ⅇ}^{jϕ} ) = \frac{1}{2} \vert {Δ}_{1}^{2} - {( {ⅇ}^{jϕ} {Δ}_{2} )}^{2} \vert$$

where Δ_{1,2}ε{±1, ±j, ±1±j}.

As discussed, each tone or symbol can be rotated differently. For example, a first symbol can be applied QPSK, a second symbol can be applied a binary phase shift keying (BPSK), and n^{th} symbol can be applied 16 quadrature amplitude modulation (16 QAM). To put differently, each tone or symbol has different modulation angle.

In rotation OFDM/MC-CDM (R-OFDM/MC-CDM),

$$\hat{H} = \tilde{H} {U}_{2} = [ \begin{matrix}{\tilde{h}}_{1} & \\ & {\tilde{h}}_{2}\end{matrix} ] [ \begin{matrix}α & β \\ - {β}^{*} & {α}^{*}\end{matrix} ] = [ \begin{matrix}{\tilde{h}}_{1} α & {\tilde{h}}_{1} β \\ - {\tilde{h}}_{2} {β}^{*} & {\tilde{h}}_{2} {α}^{*}\end{matrix} ] .$$

For rotated MC-CDM, the combined frequency-domain channel response matrix can be as shown in Equation 5.

$$\hat{H} ( {θ}_{1} ) = \tilde{H} {R}_{2} ( {θ}_{1} ) = [ \begin{matrix}{\tilde{h}}_{1} & \\ & {\tilde{h}}_{2}\end{matrix} ] [ \begin{matrix}cos ( {θ}_{1} ) & sin ( {θ}_{1} ) \\ - sin ( {θ}_{1} ) & cos ( {θ}_{1} )\end{matrix} ] = [ \begin{matrix}{\tilde{h}}_{1} cos ( {θ}_{1} ) & {\tilde{h}}_{1} sin ( {θ}_{1} ) \\ - {\tilde{h}}_{2} sin ( {θ}_{1} ) & {\tilde{h}}_{2} cos ( {θ}_{1} )\end{matrix} ] \qquad [ Equation 5 ]$$

The effect of the transform can be illustrated in a correlation matrix of Equation 6.

$$\begin{matrix}C = {\hat{H}}^{- H} H \\ = [ \begin{matrix}{\tilde{h}}_{1}^{*} {α}^{*} & - {\tilde{h}}_{2}^{*} β \\ {\tilde{h}}_{1}^{*} {β}^{*} & {\tilde{h}}_{2}^{*} {α}^{*}\end{matrix} ] [ \begin{matrix}{\tilde{h}}_{1} α & {\tilde{h}}_{1} β \\ - {\tilde{h}}_{2} {β}^{*} & {\tilde{h}}_{2} {α}^{*}\end{matrix} ] \\ = [ \begin{matrix}{\vert {\tilde{h}}_{1} \vert}^{2} {\vert α \vert}^{2} + \vert {\tilde{h}}_{2} \vert {\vert β \vert}^{2} & ( {\vert {\tilde{h}}_{1} \vert}^{2} - {\vert {\tilde{h}}_{2} \vert}^{2} ) {α}^{*} β \\ ( - {\vert {\tilde{h}}_{1} \vert}^{2} - {\vert {\tilde{h}}_{2} \vert}^{2} ) {αβ}^{*} & {\vert {\tilde{h}}_{2} \vert}^{2} {\vert α \vert}^{2} + {\vert {\tilde{h}}_{1} \vert}^{2} {\vert β \vert}^{2}\end{matrix} ] \\ = D + I \\ = [ \begin{matrix}{\vert {\tilde{h}}_{1} \vert}^{2} {\vert α \vert}^{2} + {\vert {\tilde{h}}_{2} \vert}^{2} {\vert β \vert}^{2} & 0 \\ 0 & {\vert {\tilde{h}}_{2} \vert}^{2} {\vert α \vert}^{2} + {\vert {\tilde{h}}_{1} \vert}^{2} {\vert β \vert}^{2}\end{matrix} ] + \\ [ \begin{matrix}0 & ( {\vert {\tilde{h}}_{1} \vert}^{2} - {\vert {\tilde{h}}_{2} \vert}^{2} ) {α}^{*} β \\ ( - {\vert {\tilde{h}}_{1} \vert}^{2} - {\vert {\tilde{h}}_{2} \vert}^{2} ) {αβ}^{*} & 0\end{matrix} ]\end{matrix} \qquad [ Equation 6 ]$$

Referring to Equation 3 the diversity can be denoted by

$$D = [ \begin{matrix}{\vert {\tilde{h}}_{1} \vert}^{2} {\vert α \vert}^{2} + {\vert {\tilde{h}}_{2} \vert}^{2} {\vert β \vert}^{2} & 0 \\ 0 & {\vert {\tilde{h}}_{2} \vert}^{2} {\vert α \vert}^{2} + {\vert {\tilde{h}}_{1} \vert}^{2} {\vert β \vert}^{2}\end{matrix} ] ,$$

and the interference matrix can be denoted

$$by I = [ \begin{matrix}0 & ( {\vert {\tilde{h}}_{1} \vert}^{2} - {\vert {\tilde{h}}_{2} \vert}^{2} ) {α}^{*} β \\ ( - {\vert {\tilde{h}}_{1} \vert}^{2} + {\vert {\tilde{h}}_{2} \vert}^{2} ) {αβ}^{*} & 0\end{matrix} ] .$$

Here, the interference matrix can be ISI or multiple access interference (MAI).

A total diversity of the generalized MC-CDM can be represented as shown in Equation 7.

$$\begin{matrix}D = Tr \{ D \} \\ = Tr \{ [ \begin{matrix}{\vert {\tilde{h}}_{1} \vert}^{2} {\vert α \vert}^{2} + {\vert {\tilde{h}}_{2} \vert}^{2} {\vert β \vert}^{2} & 0 \\ 0 & {\vert {\tilde{h}}_{2} \vert}^{2} {\vert α \vert}^{2} + {\vert {\tilde{h}}_{1} \vert}^{2} {\vert β \vert}^{2}\end{matrix} ] \} \\ = {\vert {\tilde{h}}_{1} \vert}^{2} + {\vert {\tilde{h}}_{2} \vert}^{2}\end{matrix} \qquad [ Equation 7 ]$$

Referring to Equation 4, the total diversity of the generalized MC-CDM is independent on the precoding matrix U. However, for each symbol or user, the diversity gain may be different to each.

Further, the interference of the generalized MC-CDM can be represented as shown in Equation 8.

$$\begin{matrix}I = {Tr}_{2} \{ I \} \\ = {Tr}_{2} \{ [ \begin{matrix}0 & ( {\vert {\tilde{h}}_{1} \vert}^{2} - {\vert {\tilde{h}}_{2} \vert}^{2} ) {α}^{*} β \\ ( - {\vert {\tilde{h}}_{1} \vert}^{2} + {\vert {\tilde{h}}_{2} \vert}^{2} ) {αβ}^{*} & 0\end{matrix} ] \} \\ = 2 \vert {\vert {\tilde{h}}_{1} \vert}^{2} - {\vert {\tilde{h}}_{2} \vert}^{2} \vert \vert {αβ}^{*} \vert \leq \vert {\vert {\tilde{h}}_{1} \vert}^{2} - {\vert {\tilde{h}}_{2} \vert}^{2} \vert\end{matrix} \qquad [ Equation 8 ]$$

Here, if |\tilde{h}₁|²≠|\tilde{h}₂|² and |αβ*|≠0, there is some self-interference or multi-user. interference. In other words, due to frequency-selectivity in OFDM-liked orthogonal modulation, there is possible interference if some preceding or spreading is applied. Furthermore, it can be shown that this interference can be maximized when the rotation

$$angel is θ = \frac{π}{4} .$$

In designing a MC-CDM transceiver, inter alia, an inter-symbol or multiple access signal-to-interference ratio (SIR) can be defined as follows.

$${SIR}_{1} = \frac{{\vert {\tilde{h}}_{1} \vert}^{2} {\vert α \vert}^{2} + {\vert {\tilde{h}}_{2} \vert}^{2} {\vert β \vert}^{2}}{\vert {\vert {\tilde{h}}_{1} \vert}^{2} - {\vert {\tilde{h}}_{2} \vert}^{2} \vert \vert {αβ}^{*} \vert} = \frac{{\vert α \vert}^{2} + γ {\vert β \vert}^{2}}{\vert 1 - γ \vert \vert {αβ}^{*} \vert} \qquad [ Equation 9 ]$$

Referring to Equation 9,

$$γ = \frac{{\vert {\tilde{h}}_{2} \vert}^{2}}{{\vert {\tilde{h}}_{1} \vert}^{2}}$$

denotes the channel fading difference. The SIR can be defined based on channel fading and rotation.

Rotation can also be performed based on receiver profile. This can be done through upper layer signaling. More specifically, at least two parameters can be configured, namely, spreading gain and rotation angle.

In operation, a receiver can send feedback information containing its optimum rotation angle and/or rotation index. The rotation angle and/or rotation index can be mapped to the proper rotation angle by a transmitter based on a table (or index). This table or index is known by both the transmitter and the receiver. This can be done any time when it is the best time for the transmitter and/or receiver.

For example, if the receiver (or access terminal) is registered with the network, it usually sends its profile to the network. This profile includes, inter alia, the rotation angle and/or index.

Before the transmitter decides to send signals to the receiver, it may ask the receiver as to the best rotation angle. In response, the receiver can send the best rotation angle to the transmitter. Thereafter, the transmitter can send the signals based on the feedback information and its own decision.

During transmission of the signals, the transmitter can periodically request from the receiver to send its updated rotation angle. Alternatively, the transmitter can request an update of the rotation angle from the receiver after the transmitter is finished transmitting.

At any time, the receiver can send the update (or updated rotation angle) to the transmitter. The transmission of the update (or feedback information) can be executed through an access channel, traffic channel, control channel, or other possible channels.

With respect to channel coding, coding can help minimize demodulation errors and therefore achieve the throughput in addition to signal design for higher spectral efficiency. In reality, most capacity-achieving codes are designed to balance the implementation complexity and achievable performance.

Gray code is one of an example of channel coding which is also known as reflective binary code. Gray code or the reflective binary code is a binary numeral system where two successive values differ in only one digit. FIG. 7 is an exemplary diagram illustrating an example of Gray coding.

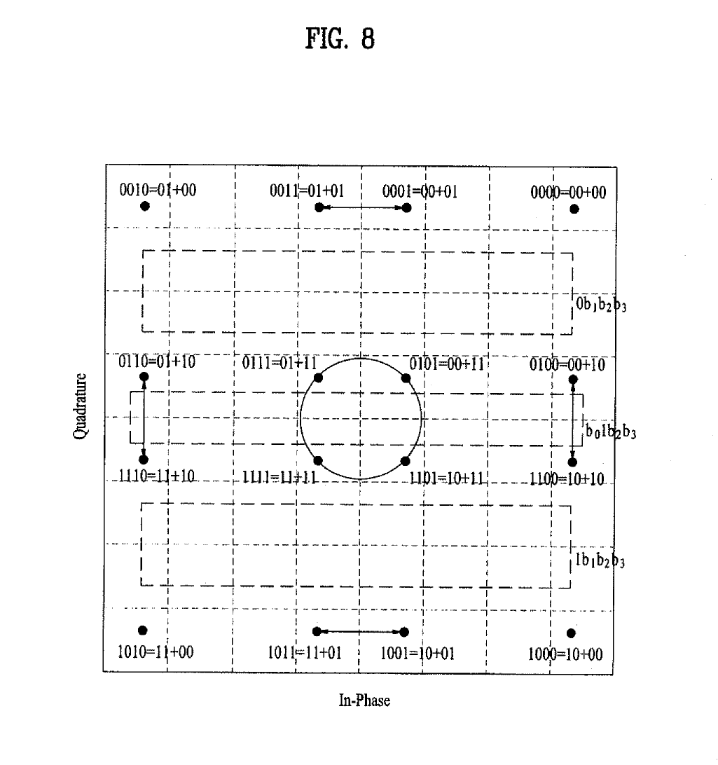

Gray code for bits-to-symbol mapping, also called Gray mapping, can be implemented with other channel coding scheme. Gray mapping is generally accepted as the optimal mapping rule for minimizing bit error rate (BER). Gray mapping for regular QPSK/QPSK hierarchical modulation (or 16 QAM modulation) is shown in FIG. 8 where the codewords with minimum Euclid distance have minimum Hamming distance as well.

In the figures to follow, the Gray mapping rule is described. More specifically, each enhancement layer bits-to-symbol and base layer bits-to-symbol satisfy the Gray mapping requirement where the closest two symbols only have difference of one or the least bit(s). Furthermore, the overall bits-to-symbol mapping rule satisfies the Gray mapping rule.

FIG. 8 is an exemplary diagram illustrating mapping for regular QPSK/QPSK hierarchical modulation or 16 QAM modulation. Referring to FIG. 8, the enhancement layer bits and the base layer bits can be arbitrarily combined so that every time when the base layer bits are detected, the enhancement layer bits-to-symbol mapping table/rule can be decided, for example. In addition, both the base layer and the enhancement layer are QPSK. Furthermore, every point (or symbol) is represented and/or mapped by b₀b₁b₂b₃.

More specifically, the circle in the center of the diagram and the lines connecting two (2) points (or symbols) (e.g., point 0011 and point 0001 or point 0110 and point 1110) represent connection with only one bit difference between neighbors. Here, the connected points are from different layers. In other words, every connected points (or symbol) are different base layer bits and enhancement layer bits.

Furthermore, every point can be represented by four (4) bits (e.g., b₀b₁b₂b₃) in which the first bit (b₀) and the third bit (b₂) represent the base layer bits, and the second bit (b₁) and the fourth bit (b₃) represent the enhancement bits. That is, two (2) bits from the base layer and the two (2) bits from the enhancement layer are interleaved together to represent every resulted point. By interleaving the bits instead of simple concatenation of the bits from two layers, additional diversity gain can be potentially attained.

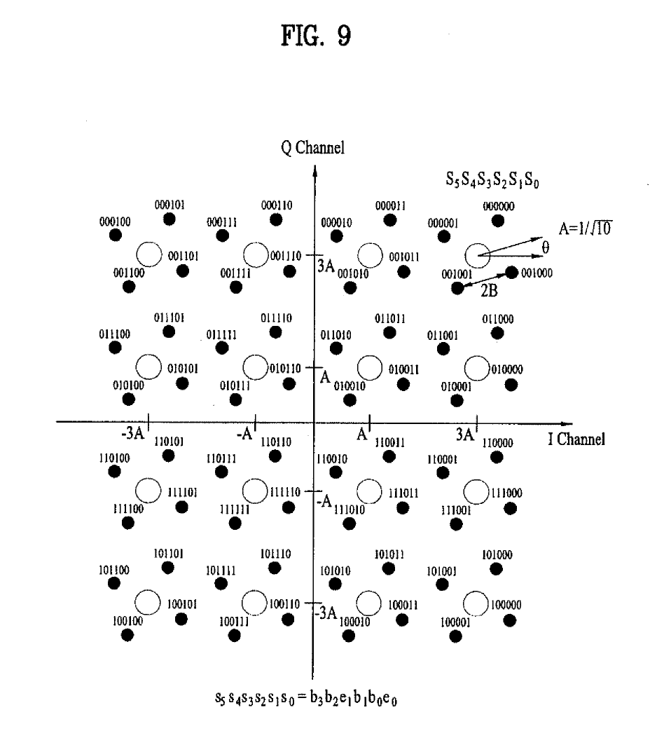

FIG. 9 is an exemplary diagram illustrating bits-to-symbol mapping for 16 QAM/QPSK. This figure refers to bits-to-symbol mapping. This mapping can be used by both the transmitter and the receiver.

If a transmitter desires to send bits b₀b₁b₂b₃b₄b₅, the transmitter needs to look for a mapped symbol to send. Hence, if a receiver desires to demodulate the received symbol, the receiver can use this figure to find/locate the demodulated bits.

Furthermore, FIG. 9 represents 16 QAM/QPSK hierarchical modulation. In other words, the base layer is modulated by 16 QAM, and the enhancement layer is modulated by QPSK. Moreover, 16 QAM/QPSK can be referred to as a special hierarchical modulation. In other words, the base layer signal and the enhancement signal have different initial phase. For example, the base layer signal phase is 0 while the enhancement layer signal phase is theta (θ).

Every symbol in FIG. 9 is represented by bits sequence, s₅s₄s₃s₁S₁s₀, in which bits S₃ and s₀ are bits from the enhancement layer while the other bits (e.g., s₅, s₄, s₂, and s₁) belong to the base layer.

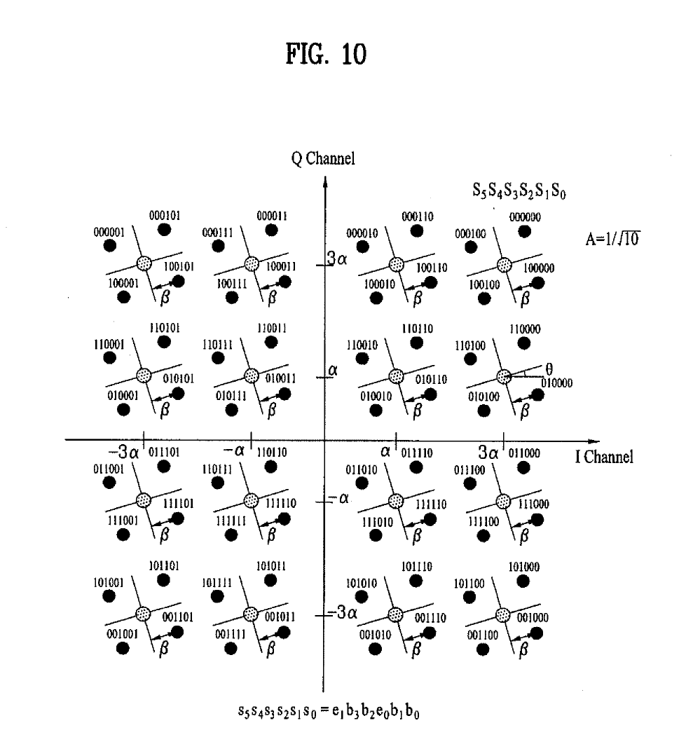

FIG. 10 is another exemplary diagram illustrating bits-to-symbol mapping for 16 QAM/QPSK. The difference between FIG. 10 and previous FIG. 9 is that every symbol in FIG. 10 is represented by bits sequence, s₅s₄s₃s₂s₁s₀ in which bits s₅ and s₂ are bits from the enhancement layer while the other bits (e.g., s₄, s₃, s₁, and s₀) are from the base layer.

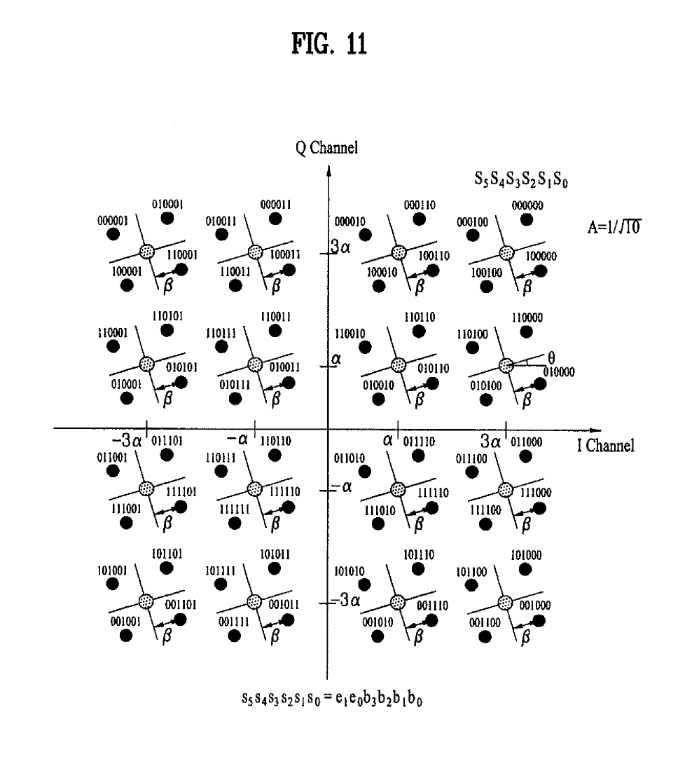

FIG. 11 is another exemplary diagram illustrating bits-to-symbol mapping for 16 QAM/QPSK. The difference between FIG. 11 and previous FIGS. 9 and/or 10 is that every symbol in FIG. 11 is represented by bits sequence, s₅s₄s₃s₂s₁s₀, in which bits s₅ and s₄ are bits from the enhancement layer while the other bits (e.g., s₃, s₂, s₁, and s₀) are from the base layer.

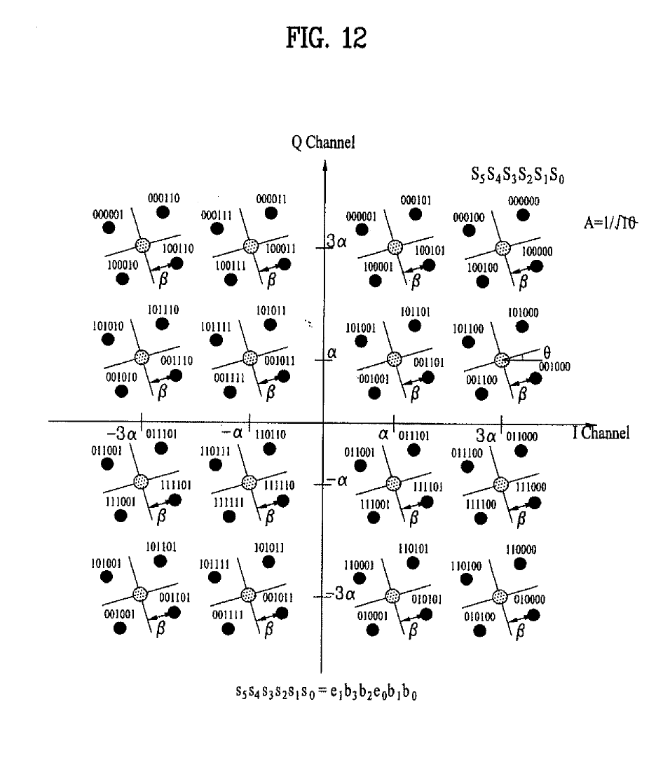

FIG. 12 is another exemplary diagram illustrating bits-to-symbol mapping for 16 QAM/QPSK. The difference between FIG. 12 and previous FIGS. 9, 10, and/or 11 bits s₅ and s₂ are bits from the enhancement layer while the other bits (e.g., s₄, s₃, s₁, and s₀) are from the base layer. As before, every symbol in FIG. 12 is represented by bits sequence, s₅s₄s₃s₂s₁s₀.

Further to bits sequence combinations as discussed above, the following hierarchical layer and enhancement layer combination possibilities include (1) s₅s₄s₃s₂s₁s₀=b₃b₂b₁e₁b₀e₀, (2) s₅s₄s₃s₂s₁s₀=b₃e₁b₂b₁b₀e₀, (3) s₅s₄s₃s₂s₁s₀=b₃b₂b₁b₀e₀e₁, (4) s₅s₄s₃s₂s₁s₀=e₀e₁b₃b₂b₁b₀, (5) s₅s₄s₃s₂s₁S₀=e₀b₃b₂e₁b₁b₀, (6) s₅s₄s₃s₂s₁s₀=b₃b₂e₀b₁b₀eₗ, (7) s₃s₂s₀=e₁bₗe₀b₀, (8) s₃s₂s₁s₀=e₀b₁eₗb₀, (9) s₃s₂s₁s₀=e₁e₀b₁b₀, (10) s₃s₂s₁s₀=e₀e₁b₁b₀, and (11) s₃s₂s₁s₀=b₁b₀e₀e₁.

In addition to the combinations discussions of above, there are many other possible combinations. However, they all follow the same rule which is the Gray rule or the Gray mapping rule. As discussed, each enhancement layer bits-to-symbol mapping and base layer bits-to-symbol mapping satisfy the Gray mapping rule requirement which is that the closest two symbols only have difference of one bit or less. Moreover, the overall bits-to-symbol mapping rule satisfies the Gray mapping rule as well.

Further, the enhancement layer bits and the base layer bits can be arbitrarily combined so that every time the base layer bits are detected, the enhancement layer bits-to-symbol mapping table/rule can be decided, In addition, it is possible, for example, for s₃s₂s₁s₀=e₁e₀b₁b₀ QPSK/QPSK, the Gray mapping rule for enhancement layer s₃s₂11=e₁e₀11 to be not the exactly the same as s₃s₂10=eₗe₀10. Moreover, for example, it is possible s₃s₂11=e₁e₀11 is a rotated version as s₃s₂10=e₁e₀10=e₁e₀11=1111's position is the position of s₃s₂11=1010 or s₃s₂11=0110.

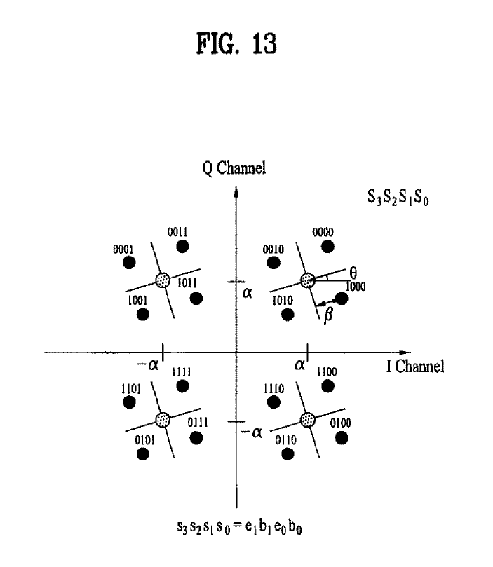

FIG. 13 is an exemplary diagram illustrating bits-to-symbol mapping for QPSK/QPSK. Referring to FIG. 13, the bits-to-symbol mapping can be used by both the transmitter and the receiver. If a transmitter desires to send bits b₀b₁b₂b₃, the transmitter needs to look for a mapped symbol to send. Hence, if a receiver desires to demodulate the received symbol, the receiver can use this figure to find/locate the demodulated bits.

Furthermore, FIG. 13 represents QPSK/QPSK hierarchical modulation. In other words, the base layer is modulated by QPSK, and the enhancement layer is also modulated by QPSK. Moreover, QPSK/QPSK can be referred to as a special hierarchical modulation. That is, the base layer signal and the enhancement signal have different initial phase. For example, the base layer signal phase is 0 while the enhancement layer signal phase is theta (θ).

Every symbol in FIG. 13 is represented by bits sequence, s₃s₂s₁s₀, in which bits s₃ and s₁ are bits from the enhancement layer while the other bits (e.g., S₂ and s₀) belong to the base layer.

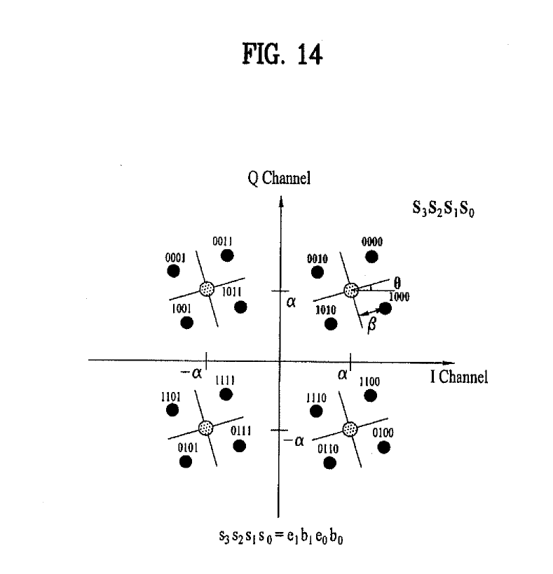

Further, in the QPSK/QPSK example, the enhancement layer bits-to-symbol mapping rules may be different from the base layer symbol-to-symbol. FIG. 14 is an exemplary diagram illustrating an enhancement layer bits-to-symbol for base layer 0x0. In other words, FIG. 14 illustrates an example of how the base layer bits are mapped.

For example, the symbols indicated in the upper right quadrant denote the base layer symbols of ‘00’. This means that as long as the base layer bits are ‘00’, whatever the enhancement layer is, the corresponding layer modulated symbol is one of the four (4) symbols of this quadrant.

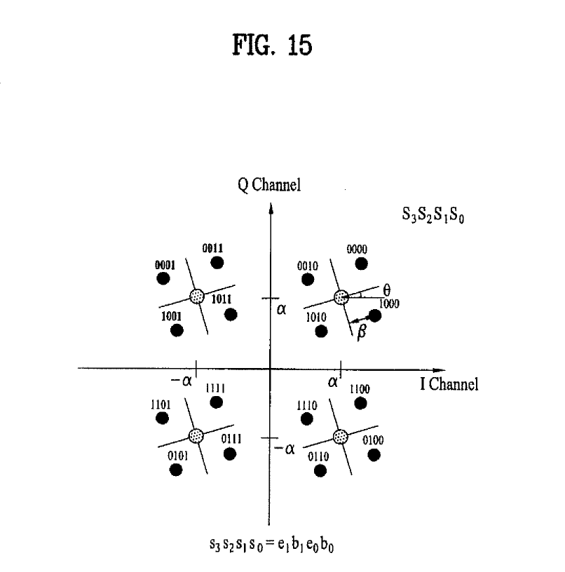

FIG. 15 is an exemplary diagram illustrating an enhancement layer bits-to-symbol for base layer 0x1. Similarly, this diagram illustrates another example of how the base layer bits are mapped. For example, the symbols of in the upper left quadrant denote the base layer symbols of ‘01’. This means that as long as the base layer bits are ‘01’, whatever the enhancement layer bits are, the corresponding layer modulated symbols is one of the symbols of the upper left quadrant.

As discussed above with respect to FIGS. 1-3, the inputted data or data stream can be channel coded using the Gray mapping rule, for example, followed by other processes including modulation. The modulation discussed here refers to layered (or superposition) modulation. The layered modulation is a type of modulation in which each modulation symbol has bits corresponding to both a base layer and an enhancement layer. In the discussions to follow, the layered modulation will be described in the context of broadcast and multicast services (BCMCS).

In general, layered modulation can be a superposition of any two modulation schemes. In BCMCS, a QPSK enhancement layer is superposed on a base QPSK or 16-QAM layer to obtain the resultant signal constellation. The energy ratio r is the power ratio between the base layer and the enhancement. Furthermore, the enhancement layer is rotated by the angle θ in counter-clockwise direction.

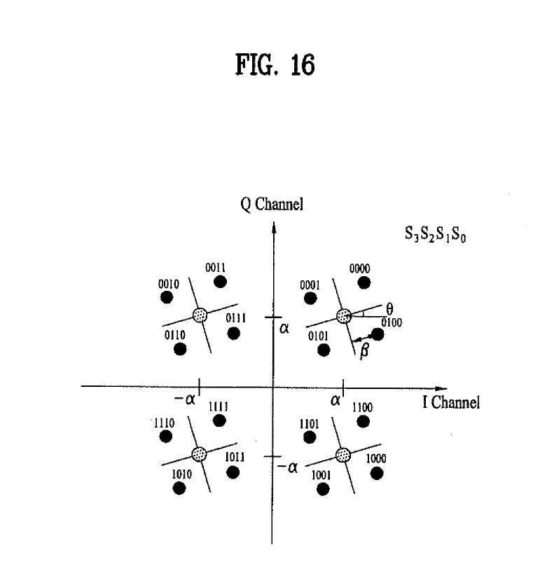

FIG. 16 is an exemplary diagram showing the signal constellation of the layered modulator with respect to QPSK/QPSK hierarchical modulation. Referring to QPSK/QPSK hierarchical modulation, which means QPSK base layer and QPSK enhancement layer, each modulation symbol contains four (4) bits, namely, s₃, s₂, s₁, s₀. Here, there are two (2) most significant bits (MSBs) which are s₃ and s₂, and two (2) least significant bits (LSBs) which are s₁ and s₀. The two (2) MSBs are from the base layer and the two LSBs come from the enhancement layer.

Given energy ratio r between the base layer and enhancement layer,

$$α = \sqrt{\frac{r}{2 ( 1 + r )}} and β = \sqrt{\frac{1}{2 ( 1 + r )}}$$

can be defined such that 2(α²+β²)=1. Here, a denotes the amplitude of the base layer, and β denotes the amplitude of enhancement layer. Moreover, 2(α²+β²)=1 is a constraint which is also referred to as power constraint and more accurately referred to as normalization.

Table 1 illustrates a layered modulation table with QPSK base layer and QPSK enhancement layer.

TABLE 1

| Modulator | | | | | |
|---|---|---|---|---|---|
| Input Bits | | | | Modulation Symbols | |
| s₃ | s₂ | s₁ | s₀ | m_{I}(k) | m_{Q}(k) |
| 0 | 0 | 0 | 0 | α + \sqrt{2} cos(θ + π/4)β | α + \sqrt{2} sin(θ + π/4)β |
| 0 | 0 | 0 | 1 | α + \sqrt{2} cos(θ + 3π/4)β | α + \sqrt{2} sin(θ + 3π/4)β |
| 0 | 1 | 0 | 1 | α + \sqrt{2} cos(θ + 7π/4)β | α + \sqrt{2} sin(θ + 7π/4)β |
| 0 | 1 | 0 | 0 | α + \sqrt{2} cos(θ + 5π/4)β | α + \sqrt{2} sin(θ + 5π/4)β |
| 0 | 0 | 1 | 1 | −α + \sqrt{2} cos(θ + π/4)β | α + \sqrt{2} sin(θ + π/4)β |
| 0 | 0 | 1 | 0 | −α + \sqrt{2} cos(θ + 3π/4)β | α + \sqrt{2} sin(θ + 3π/4)β |
| 0 | 1 | 1 | 0 | −α + \sqrt{2} cos(θ + 7π/4)β | α + \sqrt{2} sin(θ + 7π/4)β |
| 0 | 1 | 1 | 1 | −α + \sqrt{2} cos(θ + 5π/4)β | α + \sqrt{2} sin(θ + 5π/4)β |
| 1 | 1 | 0 | 0 | α + \sqrt{2} cos(θ + π/4)β | −α + \sqrt{2} sin(θ + π/4)β |
| 1 | 1 | 0 | 1 | α + \sqrt{2} cos(θ + 3π/4)β | −α + \sqrt{2} sin(θ + 3π/4)β |
| 1 | 0 | 0 | 1 | α + \sqrt{2} cos(θ + 7π/4)β | −α + \sqrt{2} sin(θ + 7π/4)β |
| 1 | 0 | 0 | 0 | α + \sqrt{2} cos(θ + 5π/4)β | −α + \sqrt{2} sin(θ + 5π/4)β |
| 1 | 1 | 1 | 1 | −α + \sqrt{2} cos(θ + π/4)β | −α + \sqrt{2} sin(θ + π/4)β |
| 1 | 1 | 1 | 0 | −α + \sqrt{2} cos(θ + 3π/4)β | −α + \sqrt{2} sin(θ + 3π/4)β |
| 1 | 0 | 1 | 0 | −α + \sqrt{2} cos(θ + 7π/4)β | −α + \sqrt{2} sin(θ + 7π/4)β |
| 1 | 0 | 1 | 1 | −α + \sqrt{2} cos(θ + 5π/4)β | −α + \sqrt{2} sin(θ + 5π/4)β |

Referring to Table 1, each column defines the symbol position for each four (4) bits, s₃, s₂, s₁, s₀. Here, the position of each symbol is given in a two-dimensional signal space (m₁, m_{Q}. This means that each symbol can be represented by S(t)=└M₁ cos(2πf₀t+φ₀)+*sin(2πf₀t+φ₀)┘φ(1). Simply put, the complex modulation symbol S=r (m₁, m_{Q}) for each [s₃, s₂, s₁, s₀] is specified in S(t)=└M₁ cos(2πf₀+φ₀)+M_{Q}*sin(2πf₀t+φ₀)┘φ(t).

Here, cos(2πf₀t+φ₀) and sin(2πf₀t+φ₀) denote the carrier signal with initial phase φ₀ and carrier frequency f₀. Moreover, φ(t) denotes the pulse-shaping, the shape of a transmit symbol.

In the above definition of S(t), except the m₁ and m_{Q} value, other parameters can usually either be shared between the transmitter and the receiver or be detected by the receiver itself. For correctly demodulating S(t), it is necessary to define and share the possible value information of m₁ and m_{Q}.

The possible value of m₁(k) and m_{Q}(k), which denote the m₁ and m_{Q} value for the k^{th} symbol, are given in Table 1. It shows for representing each group inputs bits s₃, s₂, s₁, s₀ the symbol shall be modulated by corresponding parameters shown in the table.

The discussion with respect to the complex modulation symbol can be applied in a similar or same manner to the following discussions of various layered modulations. That is, the above discussion of the complex modulation symbol can be applied to the tables to follow.

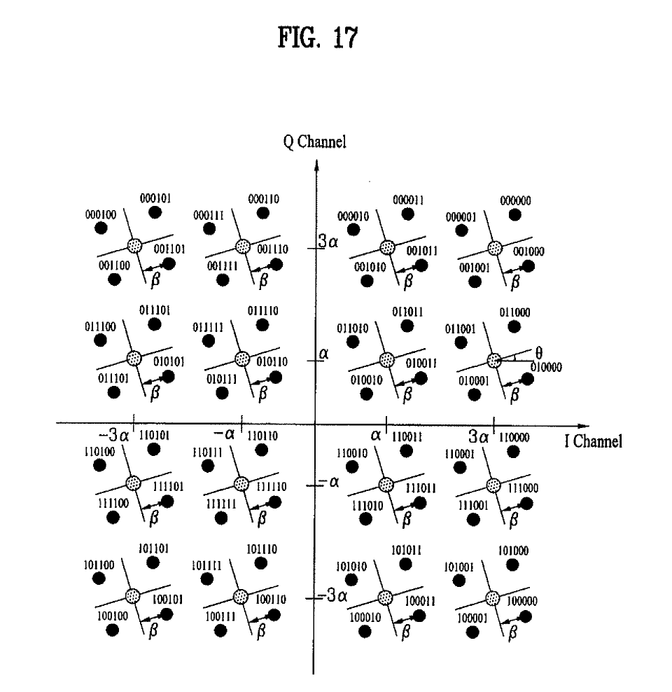

FIG. 17 is an exemplary diagram illustrating the signal constellation of the layered modulator with respect to 16 QAM/QPSK hierarchical modulation. Referring to 16 QAM/QPSK hierarchical modulation, which means 16 QAM base layer and QPSK enhancement layer, each modulation symbol contains six 6 bits—s₅, s₄, s₃, s₂, s₁, s₀. The four (4) MSBs, s₅, s₄, s₃ and s₂, come from the base layer, and the two (2) LSBs, s₁ and s₀, come from the enhancement layer.

Given energy ratio r between the base layer and enhancement layer,

$$α = \sqrt{\frac{r}{2 ( 1 + r )}} and β = \sqrt{\frac{1}{2 ( 1 + r )}}$$

can be defined such that 2(α²+β²)=1. Here, α denotes the amplitude of the base layer, and β denotes the amplitude of enhancement layer. Moreover, 2(α²+β²)=1 is a constraint which is also referred to as power constraint and more accurately referred to as normalization.

Table 2 illustrates a layered modulation table with 16 QAM base layer and QPSK enhancement layer.

TABLE 2

| Modulator Input Bits | | | | | | Modulation Symbols | |
|---|---|---|---|---|---|---|---|
| s₅ | s₄ | s₃ | s₂ | s₁ | s₀ | m_{I}(k) | m_{Q}(k) |
| 0 | 0 | 0 | 0 | 0 | 0 | 3α + \sqrt{2} cos(θ + π/4)β | 3α + \sqrt{2} sin(θ + π/4)β |
| 0 | 0 | 0 | 0 | 0 | 1 | 3α + \sqrt{2} cos(θ + 3π/4)β | 3α + \sqrt{2} sin(θ + 3π/4)β |
| 0 | 0 | 1 | 0 | 0 | 1 | 3α + \sqrt{2} cos(θ + 7π/4)β | 3α + \sqrt{2} sin(θ + 7π/4)β |
| 0 | 0 | 1 | 0 | 0 | 0 | 3α + \sqrt{2} cos(θ + 5π/4)β | 3α + \sqrt{2} sin(θ + 5π/4)β |
| 0 | 0 | 0 | 0 | 1 | 1 | α + \sqrt{2} cos(θ + π/4)β | 3α + \sqrt{2} sin(θ + π/4)β |
| 0 | 0 | 0 | 0 | 1 | 0 | α + \sqrt{2} cos(θ + 3π/4)β | 3α + \sqrt{2} sin(θ + 3π/4)β |
| 0 | 0 | 1 | 0 | 1 | 0 | α + \sqrt{2} cos(θ + 7π/4)β | 3α + \sqrt{2} sin(θ + 7π/4)β |
| 0 | 0 | 1 | 0 | 1 | 1 | α + \sqrt{2} cos(θ + 5π/4)β | 3α + \sqrt{2} sin(θ + 5π/4)β |
| 0 | 0 | 0 | 1 | 0 | 1 | −3α + \sqrt{2} cos(θ + π/4)β | 3α + \sqrt{2} sin(θ + π/4)β |
| 0 | 0 | 0 | 1 | 0 | 0 | −3α + \sqrt{2} cos(θ + 3π/4)β | 3α + \sqrt{2} sin(θ + 3π/4)β |
| 0 | 0 | 1 | 1 | 0 | 0 | −3α + \sqrt{2} cos(θ + 7π/4)β | 3α + \sqrt{2} sin(θ + 7π/4)β |
| 0 | 0 | 1 | 1 | 0 | 1 | −3α + \sqrt{2} cos(θ + 5π/4)β | 3α + \sqrt{2} sin(θ + 5π/4)β |
| 0 | 0 | 0 | 1 | 1 | 0 | −α + \sqrt{2} cos(θ + π/4)β | 3α + \sqrt{2} sin(θ + π/4)β |
| 0 | 0 | 0 | 1 | 1 | 1 | −α + \sqrt{2} cos(θ + 3π/4)β | 3α + \sqrt{2} sin(θ + 3π/4)β |
| 0 | 0 | 1 | 1 | 1 | 1 | −α + \sqrt{2} cos(θ + 7π/4)β | 3α + \sqrt{2} sin(θ + 7π/4)β |
| 0 | 0 | 1 | 1 | 1 | 0 | −α + \sqrt{2} cos(θ + 5π/4)β | 3α + \sqrt{2} sin(θ + 5π/4)β |
| 0 | 1 | 1 | 0 | 0 | 0 | 3α + \sqrt{2} cos(θ + π/4)β | α + \sqrt{2} sin(θ + π/4)β |
| 0 | 1 | 1 | 0 | 0 | 1 | 3α + \sqrt{2} cos(θ + 3π/4)β | α + \sqrt{2} sin(θ + 3π/4)β |
| 0 | 1 | 0 | 0 | 0 | 1 | 3α + \sqrt{2} cos(θ + 7π/4)β | α + \sqrt{2} sin(θ + 7π/4)β |
| 0 | 1 | 0 | 0 | 0 | 0 | 3α + \sqrt{2} cos(θ + 5π/4)β | α + \sqrt{2} sin(θ + 5π/4)β |
| 0 | 1 | 1 | 0 | 1 | 1 | α + \sqrt{2} cos(θ + π/4)β | α + \sqrt{2} sin(θ + π/4)β |
| 0 | 1 | 1 | 0 | 1 | 0 | α + \sqrt{2} cos(θ + 3π/4)β | α + \sqrt{2} sin(θ + 3π/4)β |
| 0 | 1 | 0 | 0 | 1 | 0 | α + \sqrt{2} cos(θ + 7π/4)β | α + \sqrt{2} sin(θ + 7π/4)β |
| 0 | 1 | 0 | 0 | 1 | 1 | α + \sqrt{2} cos(θ + 5π/4)β | α + \sqrt{2} sin(θ + 5π/4)β |
| 0 | 1 | 1 | 1 | 0 | 1 | −3α + \sqrt{2} cos(θ + π/4)β | α + \sqrt{2} sin(θ + π/4)β |
| 0 | 1 | 1 | 1 | 0 | 0 | −3α + \sqrt{2} cos(θ + 3π/4)β | α + \sqrt{2} sin(θ + 3π/4)β |
| 0 | 1 | 1 | 1 | 0 | 1 | −3α + \sqrt{2} cos(θ + 7π/4)β | α + \sqrt{2} sin(θ + 7π/4)β |
| 0 | 1 | 0 | 1 | 0 | 1 | −3α + \sqrt{2} cos(θ + 5π/4)β | α + \sqrt{2} sin(θ + 5π/4)β |
| 0 | 1 | 1 | 1 | 1 | 0 | −α + \sqrt{2} cos(θ + π/4)β | α + \sqrt{2} sin(θ + π/4)β |
| 0 | 1 | 1 | 1 | 1 | 1 | −α + \sqrt{2} cos(θ + 3π/4)β | α + \sqrt{2} sin(θ + 3π/4)β |
| 0 | 1 | 0 | 1 | 1 | 1 | −α + \sqrt{2} cos(θ + 7π/4)β | α + \sqrt{2} sin(θ + 7π/4)β |
| 0 | 1 | 0 | 1 | 1 | 0 | −α + \sqrt{2} cos(θ + 5π/4)β | α + \sqrt{2} sin(θ + 5π/4)β |
| 1 | 0 | 1 | 0 | 0 | 0 | 3α + \sqrt{2} cos(θ + π/4)β | −3α + \sqrt{2} sin(θ + π/4)β |
| 1 | 0 | 1 | 0 | 0 | 1 | 3α + \sqrt{2} cos(θ + 3π/4)β | −3α + \sqrt{2} sin(θ + 3π/4)β |
| 1 | 0 | 0 | 0 | 0 | 1 | 3α + \sqrt{2} cos(θ + 7π/4)β | −3α + \sqrt{2} sin(θ + 7π/4)β |
| 1 | 0 | 0 | 0 | 0 | 0 | 3α + \sqrt{2} cos(θ + 5π/4)β | −3α + \sqrt{2} sin(θ + 5π/4)β |
| 1 | 0 | 1 | 0 | 1 | 1 | α + \sqrt{2} cos(θ + π/4)β | −3α + \sqrt{2} sin(θ + π/4)β |
| 1 | 0 | 1 | 0 | 1 | 0 | α + \sqrt{2} cos(θ + 3π/4)β | −3α + \sqrt{2} sin(θ + 3π/4)β |
| 1 | 0 | 0 | 0 | 1 | 0 | α + \sqrt{2} cos(θ + 7π/4)β | −3α + \sqrt{2} sin(θ + 7π/4)β |
| 1 | 0 | 0 | 0 | 1 | 1 | α + \sqrt{2} cos(θ + 5π/4)β | −3α + \sqrt{2} sin(θ + 5π/4)β |
| 1 | 0 | 1 | 1 | 0 | 1 | −3α + \sqrt{2} cos(θ + π/4)β | −3α + \sqrt{2} sin(θ + π/4)β |
| 1 | 0 | 1 | 1 | 0 | 0 | −3α + \sqrt{2} cos(θ + 3π/4)β | −3α + \sqrt{2} sin(θ + 3π/4)β |
| 1 | 0 | 0 | 1 | 0 | 0 | −3α + \sqrt{2} cos(θ + 7π/4)β | −3α + \sqrt{2} sin(θ + 7π/4)β |
| 1 | 0 | 0 | 1 | 0 | 1 | −3α + \sqrt{2} cos(θ + 5π/4)β | −3α + \sqrt{2} sin(θ + 5π/4)β |
| 1 | 0 | 1 | 1 | 1 | 0 | −α + \sqrt{2} cos(θ + π/4)β | −3α + \sqrt{2} sin(θ + π/4)β |
| 1 | 0 | 1 | 1 | 1 | 1 | −α + \sqrt{2} cos(θ + 3π/4)β | −3α + \sqrt{2} sin(θ + 3π/4)β |
| 1 | 0 | 0 | 1 | 1 | 1 | −α + \sqrt{2} cos(θ + 7π/4)β | −3α + \sqrt{2} sin(θ + 7π/4)β |
| 1 | 0 | 0 | 1 | 1 | 0 | −α + \sqrt{2} cos(θ + 5π/4)β | −3α + \sqrt{2} sin(θ + 5π/4)β |
| 1 | 1 | 0 | 1 | 0 | 1 | 3α + \sqrt{2} cos(θ + π/4)β | −α + \sqrt{2} sin(θ + π/4)β |
| 1 | 1 | 0 | 1 | 0 | 0 | 3α + \sqrt{2} cos(θ + 3π/4)β | −α + \sqrt{2} sin(θ + 3π/4)β |
| 1 | 1 | 1 | 1 | 0 | 0 | 3α + \sqrt{2} cos(θ + 7π/4)β | −α + \sqrt{2} sin(θ + 7π/4)β |
| 1 | 1 | 1 | 1 | 0 | 1 | 3α + \sqrt{2} cos(θ + 5π/4)β | −α + \sqrt{2} sin(θ + 5π/4)β |
| 1 | 1 | 0 | 1 | 1 | 0 | α + \sqrt{2} cos(θ + π/4)β | −α + \sqrt{2} sin(θ + π/4)β |
| 1 | 1 | 0 | 1 | 1 | 1 | α + \sqrt{2} cos(θ + 3π/4)β | −α + \sqrt{2} sin(θ + 3π/4)β |
| 1 | 1 | 1 | 1 | 1 | 1 | α + \sqrt{2} cos(θ + 7π/4)β | −α + \sqrt{2} sin(θ + 7π/4)β |
| 1 | 1 | 1 | 1 | 1 | 0 | α + \sqrt{2} cos(θ + 5π/4)β | −α + \sqrt{2} sin(θ + 5π/4)β |
| 1 | 1 | 0 | 1 | 0 | 1 | −3α + \sqrt{2} cos(θ + π/4)β | −α + \sqrt{2} sin(θ + π/4)β |
| 1 | 1 | 0 | 1 | 0 | 0 | −3α + \sqrt{2} cos(θ + 3π/4)β | −α + \sqrt{2} sin(θ + 3π/4)β |
| 1 | 1 | 1 | 1 | 0 | 0 | −3α + \sqrt{2} cos(θ + 7π/4)β | −α + \sqrt{2} sin(θ + 7π/4)β |
| 1 | 1 | 1 | 1 | 0 | 1 | −α + \sqrt{2} cos(θ + 5π/4)β | −α + \sqrt{2} sin(θ + 5π/4)β |
| 1 | 1 | 0 | 1 | 1 | 0 | −α + \sqrt{2} cos(θ + π/4)β | −α + \sqrt{2} sin(θ + π/4)β |
| 1 | 1 | 0 | 1 | 1 | 1 | −α + \sqrt{2} cos(θ + 3π/4)β | −α + \sqrt{2} sin(θ + 3π/4)β |
| 1 | 1 | 1 | 1 | 1 | 1 | −α + \sqrt{2} cos(θ + 7π/4)β | −α + \sqrt{2} sin(θ + 7π/4)β |
| 1 | 1 | 1 | 1 | 1 | 0 | −α + \sqrt{2} cos(θ + 5π/4)β | −α + \sqrt{2} sin(θ + 5π/4)β |

Referring to Table 2, each column defines the symbol position for each six (6) bits, s₅, s₄, s₃, s₂, s₁, s₀. Here, the position of each symbol is given in a two-dimensional signal space (m₁, m_{Q}). This means that each symbol can be represented by S(t) └M₁ cos(2πf₀t+φ₀)+M_{Q}*sin(2πf₀t+φ₀)┘φ(t). Simply put, the complex modulation symbol S=(m₁, m_{Q}) for each [s₅, s₄, s₃, s₂, s₁, s₀] is specified in S(t)=└M₁ cos(2πf₀t+φ₀))+M_{Q}*sin(2πf₀t+φ₀)┘φ(t).

Here, w₀ denotes carrier frequency, π₀ denotes an initial phase of the carrier, and φ(t) denotes the symbol shaping or pulse shaping wave. Here, cos(2πf₀t+φ₀) and sin(2πf₀t+φ₀) denote the carrier signal with initial phase φ₀ and carrier frequency f₀ Moreover, φ(t) denotes the pulse-shaping, the shape of a transmit symbol.

In the above definition of S(t), except the m₁ and m_{Q} value, other parameters can usually either be shared between the transmitter and the receiver or be detected by the receiver itself. For correctly demodulating S(i), it is necessary to define and share the possible value information of m₁ and m_{Q}.

The possible value of m₁(k) and m_{Q}(k), which denote the m₁ and m_{Q} value for the k^{th} symbol, are given in Table 1. It shows for representing each group inputs bits s₅, s₄, s₃, s₂, s₁, s₀ the symbol shall be modulated by corresponding parameters shown in the table.

Further, another application example for BCMCS for hierarchical modulation is discussed below. In general, layered modulation can be a superposition of any two modulation schemes. In BCMCS, a QPSK enhancement layer is superposed on a base QPSK or 16-QAM layer to obtain the resultant signal constellation. The energy ratio r is the power ratio between the base layer and the enhancement. Furthermore, the enhancement layer is rotated by the angle θ in counter-clockwise direction.

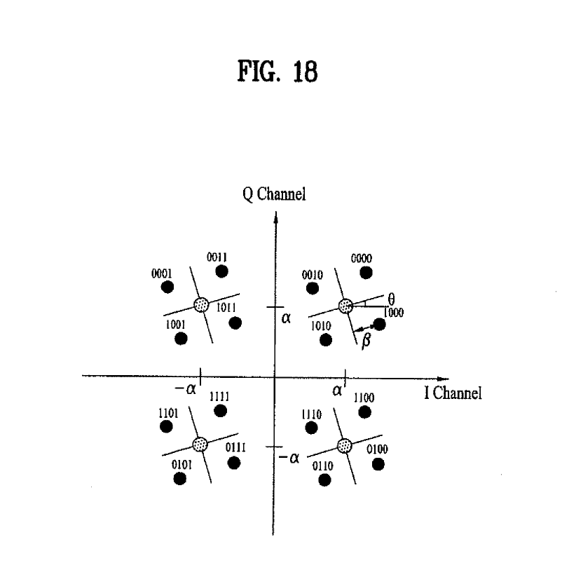

FIG. 18 is an exemplary diagram showing the signal constellation for the layered modulator with QPSK/QPSK hierarchical modulation. Referring to QPSK/QPSK hierarchical modulation, which means QPSK base layer and QPSK enhancement layer, each modulation symbol contains four (4) bits, namely, s₃, s₂, s₁, s₀. Here, there are two (2) MSBs which are s₃ and s₂, and two (2) LSBs which are s₁ and s₀. The two (2) MSBs are from the base layer and the two LSBs come from the enhancement layer.

Given energy ratio r between the base layer and enhancement layer,

$$α = \sqrt{\frac{r}{2 ( 1 + r )}} and β = \sqrt{\frac{1}{2 ( 1 + r )}}$$

can be defined such that 2(α²+β²)=1. Here, a denotes the amplitude of the base layer, and p denotes the amplitude of enhancement layer. Moreover, 2(α²+β²)=1 is a constraint which is also referred to as power constraint and more accurately referred to as normalization.

Table 3 illustrates a layered modulation table with QPSK base layer and QPSK enhancement layer.

TABLE 3

| Modulator | | | | | |
|---|---|---|---|---|---|
| Input Bits | | | | Modulation Symbols | |
| s₃ | s₂ | s₁ | s₀ | m_{I}(k) | m_{Q}(k) |
| 0 | 0 | 0 | 0 | α + \sqrt{2} cos(θ + π/4)β | α + \sqrt{2} sin(θ + π/4)β |
| 0 | 0 | 1 | 0 | α + \sqrt{2} cos(θ + 3π/4)β | α + \sqrt{2} sin(θ + 3π/4)β |
| 1 | 0 | 0 | 0 | α + \sqrt{2} cos(θ + 7π/4)β | α + \sqrt{2} sin(θ + 7π/4)β |
| 1 | 0 | 1 | 0 | α + \sqrt{2} cos(θ + 5π/4)β | α + \sqrt{2} sin(θ + 5π/4)β |
| 0 | 0 | 1 | 1 | −α + \sqrt{2} cos(θ + π/4)β | α + \sqrt{2} sin(θ + π/4)β |
| 0 | 0 | 0 | 1 | −α + \sqrt{2} cos(θ + 3π/4)β | α + \sqrt{2} sin(θ + 3π/4)β |
| 1 | 0 | 1 | 1 | −α + \sqrt{2} cos(θ + 7π/4)β | α + \sqrt{2} sin(θ + 7π/4)β |
| 1 | 0 | 0 | 1 | −α + \sqrt{2} cos(θ + 5π/4)β | α + \sqrt{2} sin(θ + 5π/4)β |
| 1 | 1 | 0 | 0 | α + \sqrt{2} cos(θ + π/4)β | −α + \sqrt{2} sin(θ + π/4)β |
| 1 | 1 | 1 | 0 | α + \sqrt{2} cos(θ + 3π/4)β | −α + \sqrt{2} sin(θ + 3π/4)β |
| 0 | 1 | 0 | 0 | α + \sqrt{2} cos(θ + 7π/4)β | −α + \sqrt{2} sin(θ + 7π/4)β |
| 0 | 1 | 1 | 0 | α + \sqrt{2} cos(θ + 5π/4)β | −α + \sqrt{2} sin(θ + 5π/4)β |
| 1 | 1 | 1 | 1 | −α + \sqrt{2} cos(θ + π/4)β | −α + \sqrt{2} sin(θ + π/4)β |
| 1 | 1 | 0 | 1 | −α + \sqrt{2} cos(θ + 3π/4)β | −α + \sqrt{2} sin(θ + 3π/4)β |
| 0 | 1 | 1 | 1 | −α + \sqrt{2} cos(θ + 7π/4)β | −α + \sqrt{2} sin(θ + 7π/4)β |
| 0 | 1 | 0 | 1 | −α + \sqrt{2} cos(θ + 5π/4)β | −α + \sqrt{2} sin(θ + 5π/4)β |

Referring to Table 3, each column defines the symbol position for each four (4) bits, s₃, s₂, s₁, s₀. Here, the position of each symbol is given in a two-dimensional signal space (m₁, m_{Q}). This means that each symbol can be represented by S(t)=└M₁ cos(2πf₀t+φ₀)+M_{Q}*sin(2πf₀t+φ₀)┘φ(t). Simply put, the complex modulation symbol S=(m₁, m_{Q}) for each [s₃, s₂, s₁, s₀] is specified in S(t)=└M₁ cos(2πf₀t+φ₀)+M_{Q}*sin(2πf₀t+φ₀)┘φ(t).

Here, cos(2πf₀t+φ₀) and sin(2πf₀t+φ₀) denote the carrier signal with initial phase φ₀ and carrier frequency f₀. Moreover, φ(t) denotes the pulse-shaping, the shape of a transmit symbol.

In the above definition of S(t), except the m₁ and m_{Q} value, other parameters can usually either be shared between the transmitter and the receiver or be detected by the receiver itself. For correctly demodulating S(t), it is necessary to define and share the possible value information of m₁ and m_{Q}.

The possible value of m₁(k) and m_{Q}(k), which denote the m₁ and m_{Q} value for the k^{th} symbol, are given in Table 1. It shows for representing each group inputs bits s₃, s₂, s₁, s₀ the symbol shall be modulated by corresponding parameters shown in the table.

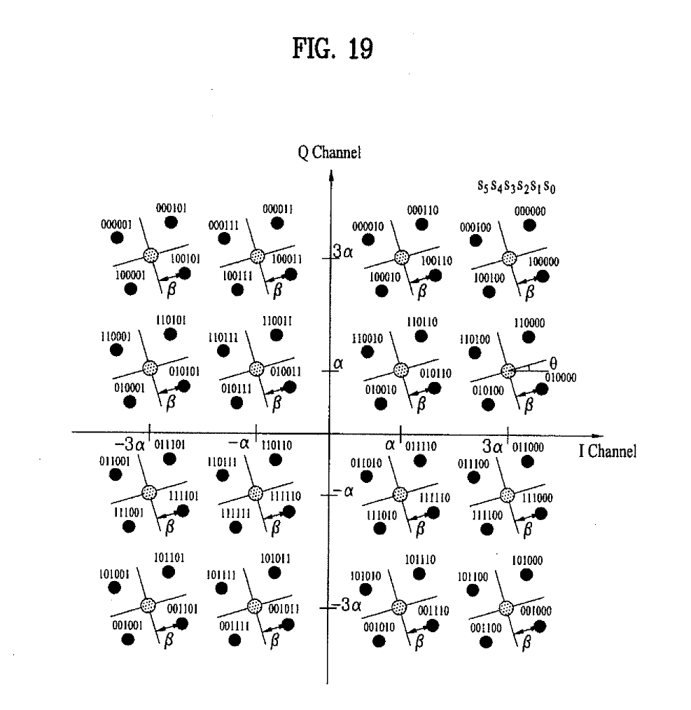

FIG. 19 is an exemplary diagram illustrating the signal constellation of the layered modulator with respect to 16 QAM/QPSK hierarchical modulation. Referring to another 16 QAM/QPSK hierarchical modulation, which means 16 QAM base layer and QPSK enhancement layer, each modulation symbol contains six (6) bits—s₅, s₄, s₃, s₂, s₁, s₀. The four (4) MSBs, s₅, s₄, s₃ and s₂, come from the base layer, and the two (2) LSBs, s₁ and s₀, come from the enhancement layer.

Given energy ratio r between the base layer and enhancement layer,

$$α = \sqrt{\frac{r}{2 ( 1 + r )}} and β = \sqrt{\frac{1}{2 ( 1 + r )}}$$

can be defined such that 2(α²+β²)=1. Here, α denotes the amplitude of the base layer, and β denotes the amplitude of enhancement layer. Moreover, 2(α²+β²)=1 is a constraint which is also referred to as power constraint and more accurately referred to as normalization.

Table 4 illustrates a layered modulation table with 16 QAM base layer and QPSK enhancement layer.

TABLE 4

| Modulator Input Bits | | | | | | Modulation Symbols | |
|---|---|---|---|---|---|---|---|
| s₅ | s₄ | s₃ | s₂ | s₁ | s₀ | m_{I}(k) | m_{Q}(k) |
| 0 | 0 | 0 | 0 | 0 | 0 | 3α + \sqrt{2} cos(θ + π/4)β | 3α + \sqrt{2} sin(θ + π/4)β |
| 0 | 0 | 0 | 1 | 0 | 0 | 3α + \sqrt{2} cos(θ + 3π/4)β | 3α + \sqrt{2} sin(θ + 3π/4)β |
| 1 | 0 | 0 | 0 | 0 | 0 | 3α + \sqrt{2} cos(θ + 7π/4)β | 3α + \sqrt{2} sin(θ + 7π/4)β |
| 1 | 0 | 0 | 1 | 0 | 0 | 3α + \sqrt{2} cos(θ + 5π/4)β | 3α + \sqrt{2} sin(θ + 5π/4)β |
| 0 | 0 | 0 | 1 | 1 | 0 | α + \sqrt{2} cos(θ + π/4)β | 3α + \sqrt{2} sin(θ + π/4)β |
| 0 | 0 | 0 | 0 | 1 | 0 | α + \sqrt{2} cos(θ + 3π/4)β | 3α + \sqrt{2} sin(θ + 3π/4)β |
| 1 | 0 | 0 | 1 | 1 | 0 | α + \sqrt{2} cos(θ + 7π/4)β | 3α + \sqrt{2} sin(θ + 7π/4)β |
| 1 | 0 | 0 | 0 | 1 | 0 | α + \sqrt{2} cos(θ + 5π/4)β | 3α + \sqrt{2} sin(θ + 5π/4)β |
| 0 | 0 | 0 | 1 | 0 | 1 | −3α + \sqrt{2} cos(θ + π/4)β | 3α + \sqrt{2} sin(θ + π/4)β |
| 0 | 0 | 0 | 0 | 0 | 1 | −3α + \sqrt{2} cos(θ + 3π/4)β | 3α + \sqrt{2} sin(θ + 3π/4)β |
| 1 | 0 | 0 | 1 | 0 | 1 | −3α + \sqrt{2} cos(θ + 7π/4)β | 3α + \sqrt{2} sin(θ + 7π/4)β |
| 1 | 0 | 0 | 0 | 0 | 1 | −3α + \sqrt{2} cos(θ + 5π/4)β | 3α + \sqrt{2} sin(θ + 5π/4)β |
| 0 | 0 | 0 | 0 | 1 | 1 | −α + \sqrt{2} cos(θ + π/4)β | 3α + \sqrt{2} sin(θ + π/4)β |
| 0 | 0 | 0 | 1 | 1 | 1 | −α + \sqrt{2} cos(θ + 3π/4)β | 3α + \sqrt{2} sin(θ + 3π/4)β |
| 1 | 0 | 0 | 0 | 1 | 1 | −α + \sqrt{2} cos(θ + 7π/4)β | 3α + \sqrt{2} sin(θ + 7π/4)β |
| 1 | 0 | 0 | 1 | 1 | 1 | −α + \sqrt{2} cos(θ + 5π/4)β | 3α + \sqrt{2} sin(θ + 5π/4)β |
| 1 | 1 | 0 | 0 | 0 | 0 | 3α + \sqrt{2} cos(θ + π/4)β | α + \sqrt{2} sin(θ + π/4)β |
| 1 | 1 | 0 | 1 | 0 | 0 | 3α + \sqrt{2} cos(θ + 3π/4)β | α + \sqrt{2} sin(θ + 3π/4)β |
| 0 | 1 | 0 | 0 | 0 | 0 | 3α + \sqrt{2} cos(θ + 7π/4)β | α + \sqrt{2} sin(θ + 7π/4)β |
| 0 | 1 | 0 | 1 | 0 | 0 | 3α + \sqrt{2} cos(θ + 5π/4)β | α + \sqrt{2} sin(θ + 5π/4)β |
| 1 | 1 | 0 | 1 | 1 | 0 | α + \sqrt{2} cos(θ + π/4)β | α + \sqrt{2} sin(θ + π/4)β |
| 1 | 1 | 0 | 0 | 1 | 0 | α + \sqrt{2} cos(θ + 3π/4)β | α + \sqrt{2} sin(θ + 3π/4)β |
| 0 | 1 | 0 | 1 | 1 | 0 | α + \sqrt{2} cos(θ + 7π/4)β | α + \sqrt{2} sin(θ + 7π/4)β |
| 0 | 1 | 0 | 0 | 1 | 0 | α + \sqrt{2} cos(θ + 5π/4)β | α + \sqrt{2} sin(θ + 5π/4)β |
| 1 | 1 | 0 | 1 | 0 | 1 | −3α + \sqrt{2} cos(θ + π/4)β | α + \sqrt{2} sin(θ + π/4)β |
| 1 | 1 | 0 | 0 | 0 | 1 | −3α + \sqrt{2} cos(θ + 3π/4)β | α + \sqrt{2} sin(θ + 3π/4)β |
| 0 | 1 | 0 | 1 | 0 | 1 | −3α + \sqrt{2} cos(θ + 7π/4)β | α + \sqrt{2} sin(θ + 7π/4)β |
| 0 | 1 | 0 | 0 | 0 | 1 | −3α + \sqrt{2} cos(θ + 5π/4)β | α + \sqrt{2} sin(θ + 5π/4)β |
| 1 | 1 | 0 | 0 | 1 | 1 | −α + \sqrt{2} cos(θ + π/4)β | α + \sqrt{2} sin(θ + π/4)β |
| 1 | 1 | 0 | 1 | 1 | 1 | −α + \sqrt{2} cos(θ + 3π/4)β | α + \sqrt{2} sin(θ + 3π/4)β |
| 0 | 1 | 0 | 0 | 1 | 1 | −α + \sqrt{2} cos(θ + 7π/4)β | α + \sqrt{2} sin(θ + 7π/4)β |
| 0 | 1 | 0 | 1 | 1 | 1 | −α + \sqrt{2} cos(θ + 5π/4)β | α + \sqrt{2} sin(θ + 5π/4)β |
| 1 | 0 | 1 | 0 | 0 | 0 | 3α + \sqrt{2} cos(θ + π/4)β | −3α + \sqrt{2} sin(θ + π/4)β |
| 1 | 0 | 1 | 1 | 0 | 0 | 3α + \sqrt{2} cos(θ + 3π/4)β | −3α + \sqrt{2} sin(θ + 3π/4)β |
| 0 | 0 | 1 | 0 | 0 | 0 | 3α + \sqrt{2} cos(θ + 7π/4)β | −3α + \sqrt{2} sin(θ + 7π/4)β |
| 0 | 0 | 1 | 1 | 0 | 0 | 3α + \sqrt{2} cos(θ + 5π/4)β | −3α + \sqrt{2} sin(θ + 5π/4)β |
| 1 | 0 | 1 | 1 | 1 | 0 | α + \sqrt{2} cos(θ + π/4)β | −3α + \sqrt{2} sin(θ + π/4)β |
| 1 | 0 | 1 | 0 | 1 | 0 | α + \sqrt{2} cos(θ + 3π/4)β | −3α + \sqrt{2} sin(θ + 3π/4)β |
| 0 | 0 | 1 | 1 | 1 | 0 | α + \sqrt{2} cos(θ + 7π/4)β | −3α + \sqrt{2} sin(θ + 7π/4)β |
| 0 | 0 | 1 | 0 | 1 | 0 | α + \sqrt{2} cos(θ + 5π/4)β | −3α + \sqrt{2} sin(θ + 5π/4)β |
| 1 | 0 | 1 | 1 | 0 | 1 | −3α + \sqrt{2} cos(θ + π/4)β | −3α + \sqrt{2} sin(θ + π/4)β |
| 1 | 0 | 1 | 0 | 0 | 1 | −3α + \sqrt{2} cos(θ + 3π/4)β | −3α + \sqrt{2} sin(θ + 3π/4)β |
| 0 | 0 | 1 | 1 | 0 | 1 | −3α + \sqrt{2} cos(θ + 7π/4)β | −3α + \sqrt{2} sin(θ + 7π/4)β |
| 0 | 0 | 1 | 0 | 0 | 1 | −3α + \sqrt{2} cos(θ + 5π/4)β | −3α + \sqrt{2} sin(θ + 5π/4)β |
| 1 | 0 | 1 | 0 | 1 | 1 | −α + \sqrt{2} cos(θ + π/4)β | −3α + \sqrt{2} sin(θ + π/4)β |
| 1 | 0 | 1 | 1 | 1 | 1 | −α + \sqrt{2} cos(θ + 3π/4)β | −3α + \sqrt{2} sin(θ + 3π/4)β |
| 0 | 0 | 1 | 0 | 1 | 1 | −α + \sqrt{2} cos(θ + 7π/4)β | −3α + \sqrt{2} sin(θ + 7π/4)β |
| 0 | 0 | 1 | 1 | 1 | 1 | −α + \sqrt{2} cos(θ + 5π/4)β | −3α + \sqrt{2} sin(θ + 5π/4)β |
| 0 | 1 | 1 | 0 | 0 | 0 | 3α + \sqrt{2} cos(θ + π/4)β | −α + \sqrt{2} sin(θ + π/4)β |
| 0 | 1 | 1 | 1 | 0 | 0 | 3α + \sqrt{2} cos(θ + 3π/4)β | −α + \sqrt{2} sin(θ + 3π/4)β |
| 1 | 1 | 1 | 0 | 0 | 0 | 3α + \sqrt{2} cos(θ + 7π/4)β | −α + \sqrt{2} sin(θ + 7π/4)β |
| 1 | 1 | 1 | 1 | 0 | 0 | 3α + \sqrt{2} cos(θ + 5π/4)β | −α + \sqrt{2} sin(θ + 5π/4)β |
| 0 | 1 | 1 | 1 | 1 | 0 | α + \sqrt{2} cos(θ + π/4)β | −α + \sqrt{2} sin(θ + π/4)β |
| 0 | 1 | 1 | 0 | 1 | 0 | α + \sqrt{2} cos(θ + 3π/4)β | −α + \sqrt{2} sin(θ + 3π/4)β |
| 1 | 1 | 1 | 1 | 1 | 0 | α + \sqrt{2} cos(θ + 7π/4)β | −α + \sqrt{2} sin(θ + 7π/4)β |
| 1 | 1 | 1 | 0 | 1 | 0 | α + \sqrt{2} cos(θ + 5π/4)β | −α + \sqrt{2} sin(θ + 5π/4)β |
| 0 | 1 | 1 | 1 | 0 | 1 | −3α + \sqrt{2} cos(θ + π/4)β | −α + \sqrt{2} sin(θ + π/4)β |
| 0 | 1 | 1 | 0 | 0 | 1 | −3α + \sqrt{2} cos(θ + 3π/4)β | −α + \sqrt{2} sin(θ + 3π/4)β |
| 1 | 1 | 1 | 1 | 0 | 1 | −3α + \sqrt{2} cos(θ + 7π/4)β | −α + \sqrt{2} sin(θ + 7π/4)β |
| 1 | 1 | 1 | 0 | 0 | 1 | −3α + \sqrt{2} cos(θ + 5π/4)β | −α + \sqrt{2} sin(θ + 5π/4)β |
| 0 | 1 | 1 | 0 | 1 | 1 | −α + \sqrt{2} cos(θ + π/4)β | −α + \sqrt{2} sin(θ + π/4)β |
| 0 | 1 | 1 | 1 | 1 | 1 | −α + \sqrt{2} cos(θ + 3π/4)β | −α + \sqrt{2} sin(θ + 3π/4)β |
| 1 | 1 | 1 | 0 | 1 | 1 | −α + \sqrt{2} cos(θ + 7π/4)β | −α + \sqrt{2} sin(θ + 7π/4)β |
| 1 | 1 | 1 | 1 | 1 | 1 | −α + \sqrt{2} cos(θ + 5π/4)β | −α + \sqrt{2} sin(θ + 5π/4)β |

Referring to Table 4, each column defines the symbol position for each six (6) bits, s₅, s₄, s₃, s₂, s₁, s₀. Here, the position of each symbol is given in a two-dimensional signal space (m₁, m_{Q}). This means that each symbol can be represented by S(t)=└M₁ cos(2πf₀t+φ₀)+M_{Q}*sin(2πf₀t+φ₀)┘φ(t). Simply put, the complex modulation symbol S=(m₁, m_{Q}) for each [s₅, s₄, s₃, s₂, s₁, s₀] is specified in S(t)=└M₁ cos(2πf₀t+φ₀)+M_{Q}*sin(2πf₀t+φ₀)┘φ(t).

Here, w₀ denotes carrier frequency, π₀ denotes an initial phase of the carrier, and φ(t) denotes the symbol shaping or pulse shaping wave. Here, cos(2πf₀t+φ₀) and sin(2πf₀t+φ₀) denote the carrier signal with initial phase φ₀ and carrier frequency f₀. Moreover, φ(t) denotes the pulse-shaping, the shape of a transmit symbol.

In the above definition of S(t), except the m₁ and m_{Q} value, other parameters can usually either be shared between the transmitter and the receiver or be detected by the receiver itself. For correctly demodulating S(t), it is necessary to define and share the possible value information of m₁ and m_{Q}.

The possible value of m₁(k) and m_{Q}(k), which denote the m₁ and m_{Q} value for the k^{th} symbol, are given in Table 1. It shows for representing each group inputs bits s₅, s₄, s₃, s₂, s₁, s₀ the symbol shall be modulated by corresponding parameters shown in the table.

With respect to the definitions of m₁ and m_{Q} in Table 1-4, in addition to the contents, the show that the rotation angle θ also needs to be shared along with those tables between transmitter and receiver. Table 5 can be used to address this problem regarding how the receiver and transmitter share the rotation angle information.

To this end, Table 5 can be used which defines and/or maps four (4) bits to a rotation angle. If this table is known by the receiver beforehand, then the transmitter only needs to sent four (4) bits to receiver to indicate to the receiver the initial rotation angle for demodulating next rotated layered modulated symbols. This table is an example of quantizing the rotation angle θ with four (4) bits and uniform quantization. It is possible to quantize the rotation angle θ with other number of bits and different quantization rule for different accuracy.

More specifically, this table is either shared beforehand by the transmitter and receiver (e.g., access network and access terminal), downloaded to the receiver (e.g., access terminal) over the air, or only used by the transmitter (e.g., access network) when the hierarchical modulation is enabled. The default rotation word for hierarchical modulation is 0000, which corresponds to 0.0.

Further, this table can be used by the receiver for demodulating the rotated layered modulation, Compared with the regular or un-rotated layered modulation, the initial rotation angle is essentially zero (0). This information of initial rotation angle of zero (0) indicates an implicit consensus between the transmitter and the receiver. However, for rotated layered modulation, this information may not be implicitly shared between the transmitter and/or the receiver. In other words, a mechanism to send or indicate this initial rotation angle to the receiver is necessary.

TABLE 5

| | |
|---|---|
| | Mapped |
| Bits for | Rotation Angle (degree) |

| Index | Angle Rotating | Unit: degree | Unit: radian |
|---|---|---|---|
| 0 | 0000 | 0.0 | 0.0 |
| 1 | 0001 | 2.81 | 0.04909 |
| 2 | 0011 | 5.63 | 0.09817 |
| 3 | 0010 | 8.44 | 0.1473 |
| 4 | 0110 | 11.25 | 0.1963 |
| 5 | 0111 | 14.06 | 0.2454 |
| 6 | 0101 | 16.88 | 0.2945 |
| 7 | 0100 | 19.69 | 0.3436 |
| 8 | 1100 | 22.50 | 0.3927 |
| 9 | 1101 | 25.31 | 0.4418 |
| 10 | 1111 | 28.13 | 0.4909 |
| 11 | 1110 | 30.94 | 0.5400 |
| 12 | 1010 | 33.75 | 0.5890 |
| 13 | 1011 | 36.56 | 0.6381 |
| 14 | 1001 | 39.38 | 0.6872 |
| 15 | 1000 | 42.19 | 0.7363 |

In a further application of the layered or superposition modulation for BCMCS, layered modulation can be a superposition of any two modulation schemes. In BCMCS, a QPSK enhancement layer is superposed on a base QPSK or 16-QAM layer to obtain the resultant signal constellation. The energy ratio r is the power ratio between the base layer and the enhancement. Furthermore, the enhancement layer is rotated by the angle in counter-clockwise direction.

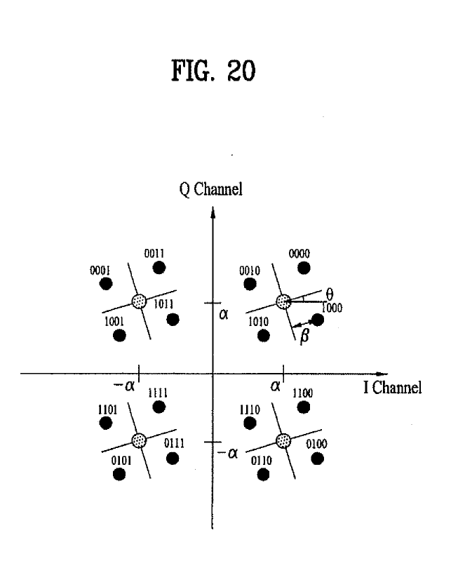

FIG. 20 is an exemplary diagram illustrating signal constellation for layered modulation with QPSK base layer and QPSK enhancement layer. Referring to FIG. 20, each modulation symbol contains four (4) bits, namely, s₃, s₂, s₁, s₀. Here, there are two (2) MSBs which are s₃ and s₁, and two (2) LSBs which are s₂ and s₀. The two (2) MSBs are from the base layer and the two LSBs come from the enhancement layer

Given energy ratio r between the base layer and enhancement layer,

$$α = \sqrt{\frac{r}{2 ( 1 + r )}} and β = \sqrt{\frac{1}{2 ( 1 + r )}}$$

can be defined such that 2(α²+β²)=1. Here, α denotes the amplitude of the base layer, and α denotes the amplitude of enhancement layer. Moreover, 2(α²'β²)=1 is a constraint which is also referred to as power constraint and more accurately referred to as normalization.

Table 6 illustrates a layered modulation table with QPSK base layer and QPSK enhancement layer.

TABLE 6

| Modulator | | | | | |
|---|---|---|---|---|---|
| Input Bits | | | | Modulation Symbols | |
| s₃ | s₂ | s₁ | s₀ | m_{I}(k) | m_{Q}(k) |
| 0 | 0 | 0 | 0 | α + \sqrt{2} cos(θ + π/4)β | α + \sqrt{2} sin(θ + π/4)β |
| 0 | 0 | 1 | 0 | α + \sqrt{2} cos(θ + 3π/4)β | α + \sqrt{2} sin(θ + 3π/4)β |
| 1 | 0 | 0 | 0 | α + \sqrt{2} cos(θ + 7π/4)β | α + \sqrt{2} sin(θ + 7π/4)β |
| 1 | 0 | 1 | 0 | α + \sqrt{2} cos(θ + 5π/4)β | α + \sqrt{2} sin(θ + 5π/4)β |
| 0 | 0 | 1 | 1 | −α + \sqrt{2} cos(θ + π/4)β | α + \sqrt{2} sin(θ + π/4)β |
| 0 | 0 | 0 | 1 | −α + \sqrt{2} cos(θ + 3π/4)β | α + \sqrt{2} sin(θ + 3π/4)β |
| 1 | 0 | 1 | 1 | −α + \sqrt{2} cos(θ + 7π/4)β | α + \sqrt{2} sin(θ + 7π/4)β |
| 1 | 0 | 0 | 1 | −α + \sqrt{2} cos(θ + 5π/4)β | α + \sqrt{2} sin(θ + 5π/4)β |
| 1 | 1 | 0 | 0 | α + \sqrt{2} cos(θ + π/4)β | −α + \sqrt{2} sin(θ + π/4)β |
| 1 | 1 | 1 | 0 | α + \sqrt{2} cos(θ + 3π/4)β | −α + \sqrt{2} sin(θ + 3π/4)β |
| 0 | 1 | 0 | 0 | α + \sqrt{2} cos(θ + 7π/4)β | −α + \sqrt{2} sin(θ + 7π/4)β |
| 0 | 1 | 1 | 0 | α + \sqrt{2} cos(θ + 5π/4)β | −α + \sqrt{2} sin(θ + 5π/4)β |
| 1 | 1 | 1 | 1 | −α + \sqrt{2} cos(θ + π/4)β | −α + \sqrt{2} sin(θ + π/4)β |
| 1 | 1 | 0 | 1 | −α + \sqrt{2} cos(θ + 3π/4)β | −α + \sqrt{2} sin(θ + 3π/4)β |
| 0 | 1 | 1 | 1 | −α + \sqrt{2} cos(θ + 7π/4)β | −α + \sqrt{2} sin(θ + 7π/4)β |
| 0 | 1 | 0 | 1 | −α + \sqrt{2} cos(θ + 5π/4)β | −α + \sqrt{2} sin(θ + 5π/4)β |

Referring to Table 6, each column defines the symbol position for each four (4) bits, s₃, s₂, s₁, s₀. Here, the position of each symbol is given in a two-dimensional signal space (m₁, m_{Q}). This means that each symbol can be represented by S(t)=M₁ cos(2πf₀t+φ₀)+M_{Q}*sin(2πf₀t+φ₀)┘φ(t). Simply put, the complex modulation symbol S=(m₁, m_{Q}) for each [s₃, s₂, s₁, s₀] is specified in S(t)=└M₁ cos(2πf₀t+φ₀)+M_{Q}*sin(2πf₀t+φ₀)┘φ(t).

Here, cos(2πf₀t+φ₀) and sin(2πf₀t+φ₀) denote the carrier signal with initial phase φ₀ and carrier frequency f₀. Moreover, φ(t) denotes the pulse-shaping, the shape of a transmit symbol.

In the above definition of S(t), except the m₁ and m_{Q} value, other parameters can usually either be shared between the transmitter and the receiver or be detected by the receiver itself. For correctly demodulating S(t), it is necessary to define and share the possible value information of m₁ and m_{Q}.

The possible value of m₁(k) and m_{Q}(k), which denote the m₁ and m_{Q} value for the k^{th} symbol, are given in Table 1. It shows for representing each group inputs bits s₃, s₂, s₁, s₀ the symbol shall be modulated by corresponding parameters shown in the table.

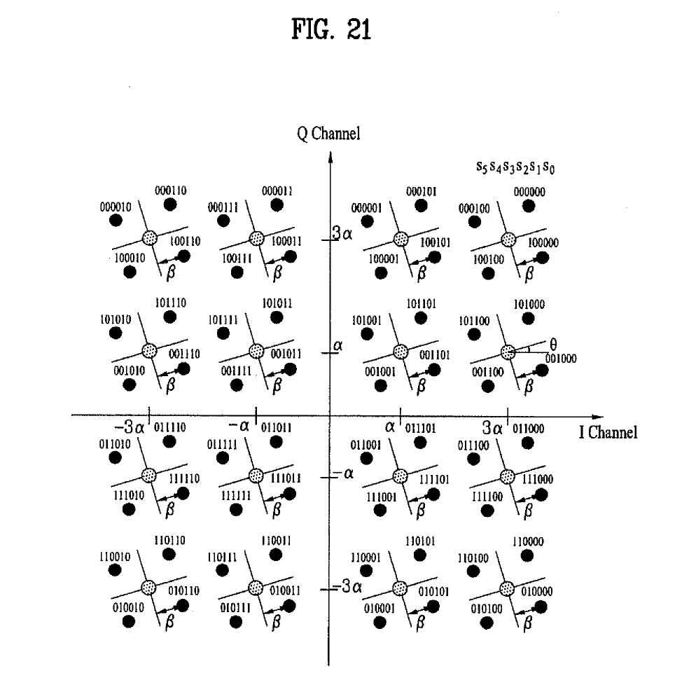

FIG. 21 is an exemplary diagram illustrating the signal constellation of the layered modulator with respect to 16 QAM/QPSK hierarchical modulation. Referring to another 16 QAM/QPSK hierarchical modulation, which means 16 QAM base layer and QPSK enhancement layer, each modulation symbol contains six (6) bits—s₅, s₄, s₃, s₂, s₁, s₀. The four (4) MSBs, s₄, s₃, s₁ and s₀, come from the base layer, and the two (2) LSBs, s₅ and s₂, come from the enhancement layer.

Given energy ratio r between the base layer and enhancement layer,

$$α = \sqrt{\frac{r}{2 ( 1 + r )}} and β = \sqrt{\frac{1}{2 ( 1 + r )}}$$

can be defined such that 2(α²+β²)=1. Here, α denotes the amplitude of the base layer, and β denotes the amplitude of enhancement layer. Moreover, 2(α²+β²)=1 is a constraint which is also referred to as power constraint and more accurately referred to as normalization.

Table 7 illustrates a layered modulation table with 16QAM base layer and QPSK enhancement layer.

TABLE 7

| Modulator Input Bits | | | | | | Modulation Symbols | |
|---|---|---|---|---|---|---|---|
| s₅ | s₄ | s₃ | s₂ | s₁ | s₀ | m_{I}(k) | m_{Q}(k) |
| 0 | 0 | 0 | 0 | 0 | 0 | 3α + \sqrt{2} cos(θ + π/4)β | 3α + \sqrt{2} sin(θ + π/4)β |
| 0 | 0 | 0 | 1 | 0 | 0 | 3α + \sqrt{2} cos(θ + 3π/4)β | 3α + \sqrt{2} sin(θ + 3π/4)β |
| 1 | 0 | 0 | 0 | 0 | 0 | 3α + \sqrt{2} cos(θ + 7π/4)β | 3α + \sqrt{2} sin(θ + 7π/4)β |
| 1 | 0 | 0 | 1 | 0 | 0 | 3α + \sqrt{2} cos(θ + 5π/4)β | 3α + \sqrt{2} sin(θ + 5π/4)β |
| 0 | 0 | 0 | 1 | 0 | 1 | α + \sqrt{2} cos(θ + π/4)β | 3α + \sqrt{2} sin(θ + π/4)β |
| 0 | 0 | 0 | 0 | 0 | 1 | α + \sqrt{2} cos(θ + 3π/4)β | 3α + \sqrt{2} sin(θ + 3π/4)β |
| 1 | 0 | 0 | 1 | 0 | 1 | α + \sqrt{2} cos(θ + 7π/4)β | 3α + \sqrt{2} sin(θ + 7π/4)β |
| 1 | 0 | 0 | 0 | 0 | 1 | α + \sqrt{2} cos(θ + 5π/4)β | 3α + \sqrt{2} sin(θ + 5π/4)β |
| 0 | 0 | 0 | 1 | 1 | 0 | −3α + \sqrt{2} cos(θ + π/4)β | 3α + \sqrt{2} sin(θ + π/4)β |
| 0 | 0 | 0 | 0 | 1 | 0 | −3α + \sqrt{2} cos(θ + 3π/4)β | 3α + \sqrt{2} sin(θ + 3π/4)β |
| 1 | 0 | 0 | 1 | 1 | 0 | −3α + \sqrt{2} cos(θ + 7π/4)β | 3α + \sqrt{2} sin(θ + 7π/4)β |
| 1 | 0 | 0 | 0 | 1 | 0 | −3α + \sqrt{2} cos(θ + 5π/4)β | 3α + \sqrt{2} sin(θ + 5π/4)β |
| 0 | 0 | 0 | 0 | 1 | 1 | −α + \sqrt{2} cos(θ + π/4)β | 3α + \sqrt{2} sin(θ + π/4)β |
| 0 | 0 | 0 | 1 | 1 | 1 | −α + \sqrt{2} cos(θ + 3π/4)β | 3α + \sqrt{2} sin(θ + 3π/4)β |
| 1 | 0 | 0 | 0 | 1 | 1 | −α + \sqrt{2} cos(θ + 7π/4)β | 3α + \sqrt{2} sin(θ + 7π/4)β |
| 1 | 0 | 0 | 1 | 1 | 1 | −α + \sqrt{2} cos(θ + 5π/4)β | 3α + \sqrt{2} sin(θ + 5π/4)β |
| 1 | 0 | 1 | 0 | 0 | 0 | 3α + \sqrt{2} cos(θ + π/4)β | α + \sqrt{2} sin(θ + π/4)β |
| 1 | 0 | 1 | 1 | 0 | 0 | 3α + \sqrt{2} cos(θ + 3π/4)β | α + \sqrt{2} sin(θ + 3π/4)β |
| 0 | 0 | 1 | 0 | 0 | 0 | 3α + \sqrt{2} cos(θ + 7π/4)β | α + \sqrt{2} sin(θ + 7π/4)β |
| 0 | 0 | 1 | 1 | 0 | 0 | 3α + \sqrt{2} cos(θ + 5π/4)β | α + \sqrt{2} sin(θ + 5π/4)β |
| 1 | 0 | 1 | 1 | 0 | 1 | α + \sqrt{2} cos(θ + π/4)β | α + \sqrt{2} sin(θ + π/4)β |
| 1 | 0 | 1 | 0 | 0 | 1 | α + \sqrt{2} cos(θ + 3π/4)β | α + \sqrt{2} sin(θ + 3π/4)β |
| 0 | 0 | 1 | 1 | 0 | 1 | α + \sqrt{2} cos(θ + 7π/4)β | α + \sqrt{2} sin(θ + 7π/4)β |
| 0 | 0 | 1 | 0 | 0 | 1 | α + \sqrt{2} cos(θ + 5π/4)β | α + \sqrt{2} sin(θ + 5π/4)β |
| 1 | 0 | 1 | 1 | 1 | 0 | −3α + \sqrt{2} cos(θ + π/4)β | α + \sqrt{2} sin(θ + π/4)β |
| 1 | 0 | 1 | 0 | 1 | 0 | −3α + \sqrt{2} cos(θ + 3π/4)β | α + \sqrt{2} sin(θ + 3π/4)β |
| 1 | 0 | 1 | 1 | 1 | 0 | −3α + \sqrt{2} cos(θ + 7π/4)β | α + \sqrt{2} sin(θ + 7π/4)β |
| 0 | 0 | 1 | 0 | 1 | 0 | −3α + \sqrt{2} cos(θ + 5π/4)β | α + \sqrt{2} sin(θ + 5π/4)β |
| 1 | 0 | 1 | 0 | 1 | 1 | −α + \sqrt{2} cos(θ + π/4)β | α + \sqrt{2} sin(θ + π/4)β |
| 1 | 0 | 1 | 1 | 1 | 1 | −α + \sqrt{2} cos(θ + 3π/4)β | α + \sqrt{2} sin(θ + 3π/4)β |
| 0 | 0 | 1 | 0 | 1 | 1 | −α + \sqrt{2} cos(θ + 7π/4)β | α + \sqrt{2} sin(θ + 7π/4)β |
| 0 | 0 | 1 | 1 | 1 | 1 | −α + \sqrt{2} cos(θ + 5π/4)β | α + \sqrt{2} sin(θ + 5π/4)β |
| 1 | 1 | 0 | 0 | 0 | 0 | 3α + \sqrt{2} cos(θ + π/4)β | −3α + \sqrt{2} sin(θ + π/4)β |
| 1 | 1 | 0 | 1 | 0 | 0 | 3α + \sqrt{2} cos(θ + 3π/4)β | −3α + \sqrt{2} sin(θ + 3π/4)β |
| 0 | 1 | 0 | 0 | 0 | 0 | 3α + \sqrt{2} cos(θ + 7π/4)β | −3α + \sqrt{2} sin(θ + 7π/4)β |
| 0 | 1 | 0 | 1 | 0 | 0 | 3α + \sqrt{2} cos(θ + 5π/4)β | −3α + \sqrt{2} sin(θ + 5π/4)β |
| 1 | 1 | 0 | 1 | 0 | 1 | α + \sqrt{2} cos(θ + π/4)β | −3α + \sqrt{2} sin(θ + π/4)β |
| 1 | 1 | 0 | 0 | 0 | 1 | α + \sqrt{2} cos(θ + 3π/4)β | −3α + \sqrt{2} sin(θ + 3π/4)β |
| 0 | 1 | 0 | 1 | 0 | 1 | α + \sqrt{2} cos(θ + 7π/4)β | −3α + \sqrt{2} sin(θ + 7π/4)β |
| 0 | 1 | 0 | 0 | 0 | 1 | α + \sqrt{2} cos(θ + 5π/4)β | −3α + \sqrt{2} sin(θ + 5π/4)β |
| 1 | 1 | 0 | 1 | 1 | 0 | −3α + \sqrt{2} cos(θ + π/4)β | −3α + \sqrt{2} sin(θ + π/4)β |
| 1 | 1 | 0 | 0 | 1 | 0 | −3α + \sqrt{2} cos(θ + 3π/4)β | −3α + \sqrt{2} sin(θ + 3π/4)β |
| 0 | 1 | 0 | 1 | 1 | 0 | −3α + \sqrt{2} cos(θ + 7π/4)β | −3α + \sqrt{2} sin(θ + 7π/4)β |
| 0 | 1 | 0 | 0 | 1 | 0 | −3α + \sqrt{2} cos(θ + 5π/4)β | −3α + \sqrt{2} sin(θ + 5π/4)β |
| 1 | 1 | 0 | 0 | 1 | 1 | −α + \sqrt{2} cos(θ + π/4)β | −3α + \sqrt{2} sin(θ + π/4)β |
| 1 | 1 | 0 | 1 | 1 | 1 | −α + \sqrt{2} cos(θ + 3π/4)β | −3α + \sqrt{2} sin(θ + 3π/4)β |
| 0 | 1 | 0 | 0 | 1 | 1 | −α + \sqrt{2} cos(θ + 7π/4)β | −3α + \sqrt{2} sin(θ + 7π/4)β |
| 0 | 1 | 0 | 1 | 1 | 1 | −α + \sqrt{2} cos(θ + 5π/4)β | −3α + \sqrt{2} sin(θ + 5π/4)β |
| 0 | 1 | 1 | 0 | 0 | 0 | 3α + \sqrt{2} cos(θ + π/4)β | −α + \sqrt{2} sin(θ + π/4)β |
| 0 | 1 | 1 | 1 | 0 | 0 | 3α + \sqrt{2} cos(θ + 3π/4)β | −α + \sqrt{2} sin(θ + 3π/4)β |
| 1 | 1 | 1 | 0 | 0 | 0 | 3α + \sqrt{2} cos(θ + 7π/4)β | −α + \sqrt{2} sin(θ + 7π/4)β |
| 1 | 1 | 1 | 1 | 0 | 0 | 3α + \sqrt{2} cos(θ + 5π/4)β | −α + \sqrt{2} sin(θ + 5π/4)β |
| 0 | 1 | 1 | 1 | 0 | 1 | α + \sqrt{2} cos(θ + π/4)β | −α + \sqrt{2} sin(θ + π/4)β |
| 0 | 1 | 1 | 0 | 0 | 1 | α + \sqrt{2} cos(θ + 3π/4)β | −α + \sqrt{2} sin(θ + 3π/4)β |
| 1 | 1 | 1 | 1 | 0 | 1 | α + \sqrt{2} cos(θ + 7π/4)β | −α + \sqrt{2} sin(θ + 7π/4)β |
| 1 | 1 | 1 | 0 | 0 | 1 | α + \sqrt{2} cos(θ + 5π/4)β | −α + \sqrt{2} sin(θ + 5π/4)β |
| 0 | 1 | 1 | 1 | 1 | 0 | −3α + \sqrt{2} cos(θ + π/4)β | −α + \sqrt{2} sin(θ + π/4)β |
| 0 | 1 | 1 | 0 | 1 | 0 | −3α + \sqrt{2} cos(θ + 3π/4)β | −α + \sqrt{2} sin(θ + 3π/4)β |
| 1 | 1 | 1 | 1 | 1 | 0 | −3α + \sqrt{2} cos(θ + 7π/4)β | −α + \sqrt{2} sin(θ + 7π/4)β |
| 1 | 1 | 1 | 0 | 1 | 0 | −3α + \sqrt{2} cos(θ + 5π/4)β | −α + \sqrt{2} sin(θ + 5π/4)β |
| 0 | 1 | 1 | 0 | 1 | 1 | −α + \sqrt{2} cos(θ + π/4)β | −α + \sqrt{2} sin(θ + π/4)β |
| 0 | 1 | 1 | 1 | 1 | 1 | −α + \sqrt{2} cos(θ + 3π/4)β | −α + \sqrt{2} sin(θ + 3π/4)β |
| 1 | 1 | 1 | 0 | 1 | 1 | −α + \sqrt{2} cos(θ + 7π/4)β | −α + \sqrt{2} sin(θ + 7π/4)β |
| 1 | 1 | 1 | 1 | 1 | 1 | −α + \sqrt{2} cos(θ + 5π/4)β | −α + \sqrt{2} sin(θ + 5π/4)β |

Referring to Table 4, each column defines the symbol position for each six (6) bits, s₅, s₄, s₃, s₁, s₀. Here, the position of each symbol is given in a two-dimensional signal space (m₁, m_{Q}). This means that each symbol can be represented by S(t)=└M₁ cos(2πf₀t+φ₀)+M_{Q}*sin(2πf₀t+φ₀)┘φ(t). Simply put, the complex modulation symbol S=(m₁, m_{Q}) for each [s₅, s₄, s₃, s₂, s₁, s₀] is specified in S(t)=└M₁ cos(2πf₀t+φ₀)+M_{Q}*sin(2πf₀t+φ₀)┘φ(t).

Here, w₀ denotes carrier frequency, π₀ denotes an initial phase of the carrier, and φ(t) denotes the symbol shaping or pulse shaping wave. Here, cos(2πf₀t+φ₀) and sin(2πf₀t+φ₀) denote the carrier signal with initial phase φ₀ and carrier frequency f₀. Moreover, φ(t) denotes the pulse-shaping, the shape of a transmit symbol.

In the above definition of S(t), except the m₁ and m_{Q} value, other parameters can usually either be shared between the transmitter and the receiver or be detected by the receiver itself. For correctly demodulating S(t), it is necessary to define and share the possible value information of m₁ and m_{Q}.

The possible value of m₁(k) and m_{Q}(k), which denote the m₁ and m_{Q} value for the k^{th} symbol, are given in Table 1. It shows for representing each group inputs bits s₅, s₄, s₃, s₂, s₁, s₀ the symbol shall be modulated by corresponding parameters shown in the table.

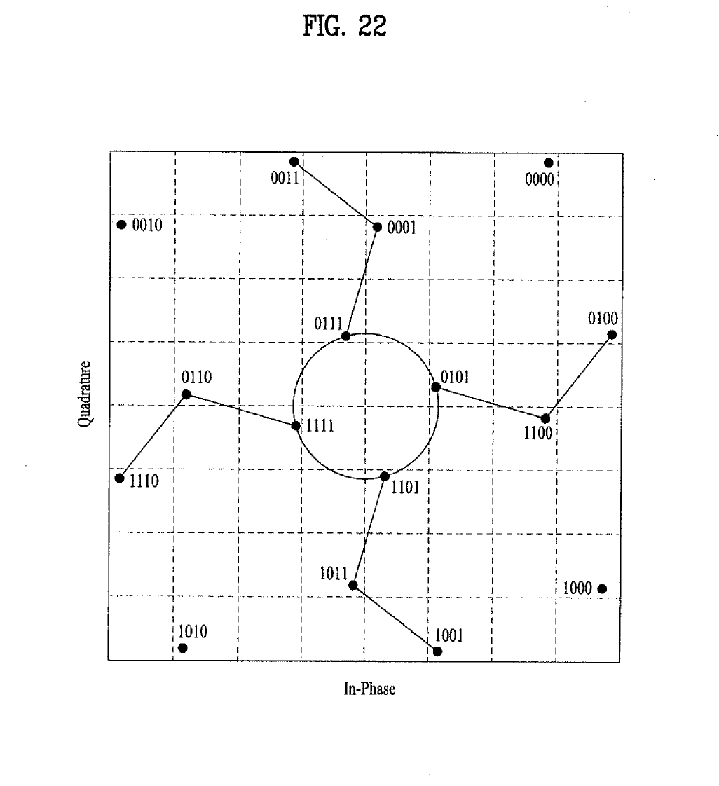

However, the Euclid distance profile can change when the enhancement layer signal constellation is rotated and the power-splitting ratio is changed. This means the original Gray mapping in Error! Reference source not found.1, for example, may not always be optimal. In this case, it may be necessary to perform bits-to-symbols remapping based on each Euclidean distance file instance. FIG. 22 is an exemplary diagram illustrating Gray mapping for rotated QPSK/QPSK hierarchical modulation.

The HER performance of a signal constellation can be dominated by symbol pairs with minimum Euclidean distance, especially when SNR is high. Therefore it is interesting to find optimal bits-to-symbol mapping rules, in which the codes for the closest two signals have minimum difference.

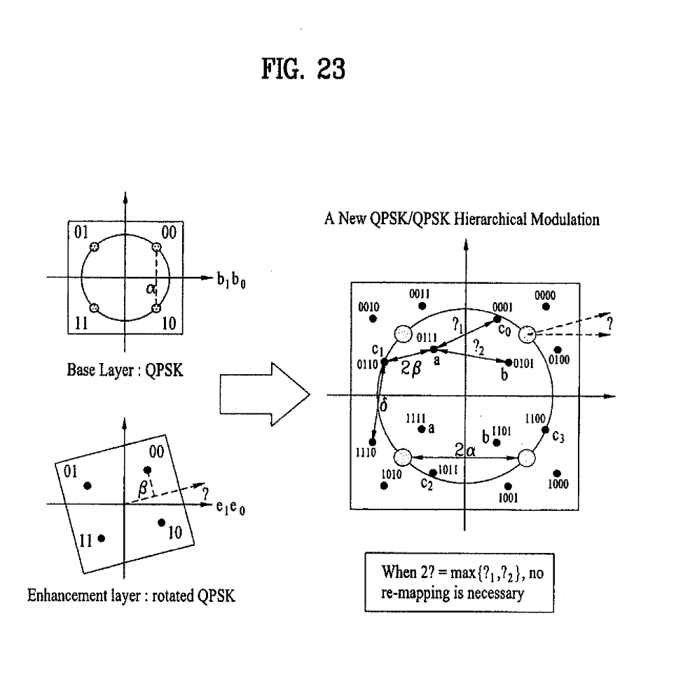

In general, Gray mapping in two-dimensional signals worked with channel coding can be accepted as optimal for minimizing HER for equally likely signals. Gray mapping for regular hierarchical signal constellations is shown in FIG. 21, where the codes for the closest two signals are different in only one bit. However, this kind of Euclidean distance profile may not be fixed in hierarchical modulation. An example of the minimum Euclidean distance of 16 QAM/QPSK hierarchical modulation with different rotation angles is shown in FIG. 23.

FIG. 23 is an exemplary diagram illustrating an enhanced QPSK/QPSK hierarchical modulation. Referring to FIG. 23, the base layered is modulated with QPSK and the enhancement layer is modulated with rotated QPSK. If the hierarchical modulation is applied, a new QPSK/QPSK hierarchical modulation can be attained as shown in this figure.

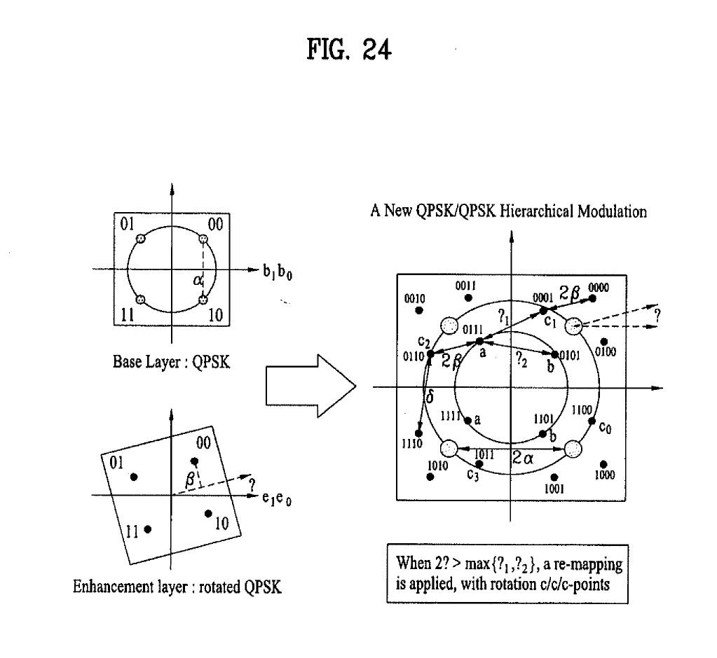

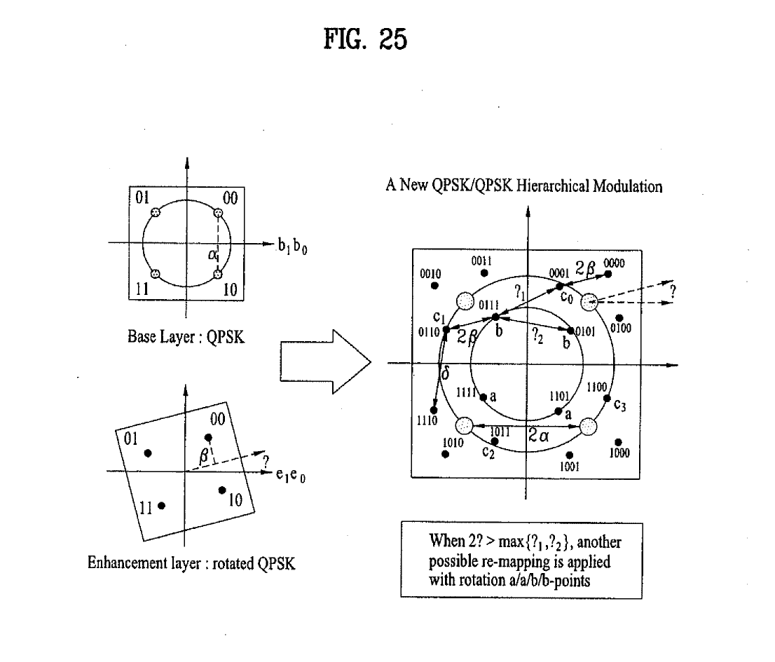

Further, the inter-layer Euclidean distance may become shortest when the power splitting ratio increases in a two-layer hierarchical modulation. This can occur if the enhancement layer is rotated. In order to minimize BER when Euclidean distance profile is changed in hierarchical modulation, the bits-to-symbol mapping can be re-done or performed again, as shown in FIGS. 24 and 25.

FIG. 24 is an exemplary diagram illustrating a new QPSK/QPSK hierarchical modulation. Moreover, FIG. 25 is another exemplary diagram illustrating a new QPSK/QPSK hierarchical modulation.

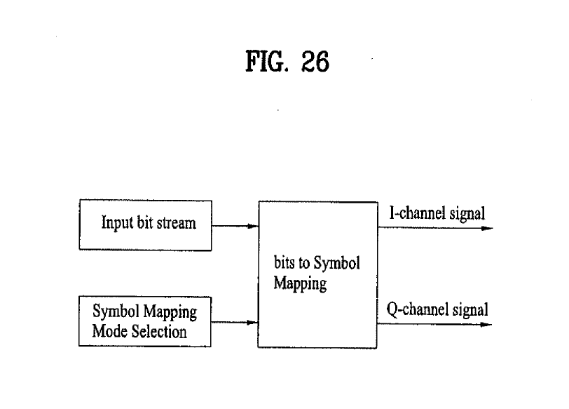

In view of the discussions of above, a new bit-to-symbol generation structure can be introduced. According to the conventional structure, a symbol mapping mode selection was not available. FIG. 26 is an exemplary diagram illustrating a new bit-to-symbol block. Here, the symbol mapping mode can be selected when the bits-to-symbol mapping is performed. More specifically, a new symbol mapping mode selection block can be added for controlling and/or selecting bits-to-symbol mapping rule based on the signal constellation of hierarchical modulation and channel coding used.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of allocating symbols in a wireless communication system, the method comprising:
receiving at least one data stream from at least one user;
grouping the at least one data streams into at least one group, wherein each group is comprised of at least one data stream;
preceding each group of data streams in multiple stages; and
allocating the precoded symbols.

2. The method of claim 1, wherein the each group of data streams is precoded independently.

3. The method of claim 2, wherein the each group of data stream is precoded independently using independent rotation matrix.

4. The method of claim 1, wherein the each group of data streams is precoded jointly.

5. The method of claim 4, wherein the each group of data streams is precoded jointly using a single rotation matrix.

6. The method of claim 1, wherein the precoding in multiple stages include applying independent spreading matrix to each group.

7. The method of claim 1, wherein the preceding includes at least one of phase adjustment or amplitude adjustment.

8. The method of claim 1, wherein the wireless communication system is any one of orthogonal frequency division multiplexing (OFDM) system, orthogonal frequency division multiple access (OFDMA) system, multi-carrier code division multiplexing (MC-CDM), or multi-carrier code division multiple access (MC-CDMA).

9. The method of claim 1, further comprising modulating the allocated symbols using an inverse fast Fourier transform (IFFT) or an inverse discrete Fourier transform (IDFT).

10. A method of performing hierarchical modulation signal constellation in a wireless communication system, the method comprising allocating multiple symbols according to a bits-to-symbol mapping rule representing different signal constellation points with different bits, wherein the mapping rule represents one (1) or less bit difference between closest two symbols.

11. The method of claim 10, wherein the multiple symbols have different initial modulation phase.

12. The method of claim 10, wherein the hierarchical modulation signal constellation includes one base layer signal constellation and at least one enhancement layer signal constellation.

13. The method of claim 12, wherein the mapping rule applied to the enhancement layer is selected from a pool of all possible enhancement layer mapping rules which is based on each base layer symbol position.

14. The method of claim 10, wherein the hierarchical modulation signal constellation includes one base layer signal constellation and at least one enhancement layer signal constellation and the mapping rule represented by a bit-to-symbol mapping rule.

15. The method of claim 10, further comprising multiplexing the bits for base layer symbol and the bits for enhancement layer symbol using interleaving or concatenating techniques.

16. The method of claim 10, further comprising:
grouping the symbols, each group having the same signal strength; and
selecting the each group from a pool of mapping rules according to the bits-to-symbol mapping rule applied to other groups.

17. The method of claim 10, wherein the modulation schemes include phase shift keying (PSK), rotated-PSK, quadrature phase shift keying (QPSK), rotated-QPSK, 8-PSK, rotated 8-PSK, 16 quadrature amplitude modulation (16 QAM), and rotated-16 QAM.

18. The method of claim 10, wherein the bits-to-symbol mapping m/e is Gray mapping rule.

19. A method of transmitting more than one signal in a wireless communication system, the method comprising:
allocating multiple symbols to a first signal constellation and to a second constellation, wherein the first signal constellation refers to base layer signals and the second signal constellation refers to enhancement layer signals;
modulating the multiple symbols of the first signal constellation and the second signal constellation; and
transmitting the modulated symbols.

20. The method of claim 19, wherein the base layer signals and the enhancement layer signals have initial modulation and transmission phase that are the same.

21. The method of claim 19, wherein the base layer signals and the enhancement layer signals have initial modulation and transmission phase that are different.

22. The method of claim 19, wherein the base layer signals and the enhancement layer signals have the same bits-to-symbol mapping rules.

23. The method of claim 19, wherein the base layer signals and the enhancement layer signals have different bits-to-symbol mapping rules.

24. The method of claim 19, wherein the transmitted modulated symbols apply bits-to-symbol mapping rule where each enhancement layer signal constellation is based on bits-to-symbol mapping rule for the base layer bits-to-symbol mapping rule and other enhancement bits-to-symbol mapping rule.
